(19) United States
(12) Patent Application Publication
(10) Pub. No.: US 2024/0018284 A1
(43) Pub. Date: Jan. 18, 2024

(54) SOLUTION PROCESS FOR PRODUCTION OF FUNCTIONALIZED POLYOLEFINS

(71) Applicant: SABIC GLOBAL TECHNOLOGIES B.V., BERGEN OP ZOOM (NL)

(72) Inventors: Miloud BOUYAHYI, Eindhoven (NL); Nydia BADILLO SAMPEDRO, Maastricht (NL); Lidia JASINSKA-WALC, Veldhoven (NL); Robbert DUCHATEAU, Roostenlaan (NL)

(21) Appl. No.: 18/037,209

(22) PCT Filed: Nov. 22, 2021
(86) PCT No.: PCT/EP2021/082511

§ 371 Date: May 16, 2023

(30) Foreign Application Priority Data
Nov. 23, 2020 (EP) 20209235.9

(51) Int. Cl. C08F 210/14; C08F 210/06

(52) U.S. Cl. CPC C08F 210/14; C08F 210/06

(57) ABSTRACT

The present invention relates to a process for solution copolymerization process to produce a functionalized polyolefin using a catalyst system comprising a hafnium or zirconium complex of a polyvalent aryloxyether and a co-catalyst selected from the group: MAO, MMAO, DMAO, SMAO or ammonium salts or trityl salts of fluorated tetraarylborates.

### TECHNICAL FIELD OF THE INVENTION

The present invention relates to a process to obtain functionalized polyolefin, in particular hydroxyl functionalized, in a solution process, and its functionalized polyolefin.

### TECHNOLOGICAL BACKGROUND OF THE INVENTION

Functionalized polyolefins are known in the art.

For example, EP3034545 discloses a process for the preparation of a graft copolymer comprising a polyolefin main chain and one or multiple polymer side chains, the process comprising the steps of:
A. copolymerizing at least one first type of olefin monomer and at least one second type of metal-pacified functionalized olefin monomer using a catalyst system to obtain a polyolefin main chain having one or multiple metal-pacified functionalized short chain branches, the catalyst system comprising:
   1. a metal catalyst or metal catalyst precursor comprising a metal from Group 3-10 of the IUPAC Periodic Table of elements;
   2. optionally a co-catalyst;
B. reacting the polyolefin main chain having one or multiple metal-pacified functionalized short chain branches obtained in step A) with at least one metal substituting agent to obtain a polyolefin main chain having one or multiple functionalized short chain branches;
C. forming one or multiple polymer side chains on the polyolefin main chain, wherein as initiators the functionalized short chain branches on the polyolefin main chain obtained in step B) are used to obtain the graft copolymer.

However, such process is generally performed under slurry condition which has important drawbacks:
The need of a specific catalyst in order to incorporate functional comonomer in high degree;
The solid content must be <15 wt % especially when a homogeneous catalyst is used, otherwise statics become a severe problem giving gels that retain a lot of diluent.
Reactor fouling occurring when using homogeneous single-site catalysts at temperatures below the crystallization temperature of the polymer being formed;
Precipitated polymer retains a large fraction of unreacted functional comonomer;
Deprotection is difficult once polymer has precipitated.

However, this process can also be realized under solution conditions. However, the following drawback appears:
Catalysts are not thermally stable, leading to low catalyst yields;
Only low MW polymers are produced with low isotacticity for the polypropylenes.

Therefore, there is a need for a process to produce functionalized polyolefins that overcome at least one of these drawbacks.

### SUMMARY

This object is achieved by the present invention. Accordingly, the present invention relates to a process for solution copolymerization to obtain a functionalized polyolefin comprising at least the following steps:
a) A copolymerization step of at least one olefin monomer and at least one protected functionalized olefin monomer in the presence of a catalyst system, wherein the olefin monomer is represented by CHR¹═CHR², wherein R¹ and R² are each independently chosen from hydrogen or a hydrocarbyl group having 1 to 6 carbon atoms, wherein the protected functionalized olefin monomer is a reaction product of a functionalized olefin monomer and a protecting agent during a protection step and the functionalized olefin monomer represented by the structure according to Formula (I):

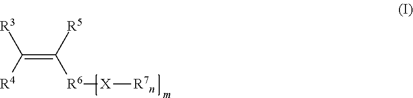

wherein R³, R⁴, and R⁵ are each independently selected from the group consisting of H and hydrocarbyl with 1 to 16 carbon atoms,
wherein R⁶—[X—(R⁷)ₙ]ₘ is a polar functional group containing m heteroatom-containing functionalities X—(R⁷)ₙ, in which m is an entire number between 1 and 10, preferably 1 or 2, wherein
   when n=1, X is selected from —O—, —S— or —CO₂— and R⁷ is H, or
   when n=2, X is N and at least one R⁷ is H and the other R⁷ is selected from the group consisting of H and a hydrocarbyl group with 1 to 16 carbon atoms,
wherein R⁶ is either —C(R⁸)(R⁹)— or a plurality of —C(R⁸)(R⁹)— groups, wherein R⁸ and R⁹ are each independently selected from the group consisting of H or hydrocarbyl with 1 to 16 carbon atoms and R 6 comprises 1 to 10 carbon atoms,
wherein X is attached to either the main chain and/or side chain of R⁶,
wherein R⁴ and R⁶ may together form a ring structure that is functionalized with one or multiple X—(R⁷)ₙ,
and wherein the catalyst system comprises
   a hafnium complex of a polyvalent aryloxyether selected from the group: bis((2-oxoyl-3-(1,2,3,4,6,7,8,9-octahydroanthracen-5-yl)-5-(methyl)phenyl)-2-phenoxy)-1,3-propanediylhafnium (IV) dimethyl, bis((2-oxoyl-3-(1,2,3,4,6,7,8,9-octahydroanthracen-5-yl)-5-(methyl)phenyl)-2-phenoxy)-1,3-propanediylhafnium (IV) dichloride, bis((2-oxoyl-3-(1,2,3,4,6,7,8,9-octahydroanthracen-5-yl)-5-(methyl)phenyl)-2-phenoxy)-1,3-propanediylhafnium (IV) dibenzyl, bis((2-oxoyl-3-(dibenzo-1H-pyrrole-1-yl)-5-(methyl)phenyl)-2-phenoxy)-1,3-propanediylhafnium (IV) dimethyl, bis((2-oxoyl-3-(dibenzo-1H-pyrrole-1-yl)-5-(methyl)phenyl)-2-phenoxy)-1,3-propanediylhafnium (IV) dichloride, bis((2-oxoyl-3-(dibenzo-1H-pyrrole-1-yl)-5-(methyl)phenyl)-2-phenoxy)-1,3-propanediylhafnium (IV) dibenzyl, bis((2-oxoyl-3-(1,2,3,4,6,7,8,9-octahydroanthracen-5-yl)-5-(methyl)phenyl)-2-phenoxymethyl)-1,4-butanediylhafnium (IV) dimethyl, bis((2-oxoyl-3-(1,2,3,4,6,7,8,9-octahydroanthracen-5-yl)-5-(methyl)phenyl)-2-phenoxymethyl)-1,4-butanediylhafnium (IV) dichloride, bis((2-oxoyl-3-(1,2,3,4,6,7,8,9-octahydroanthracen-5-yl)-5-(methyl)phenyl)-2-phenoxymethyl)-1,4-butanediylhafnium (IV) dibenzyl, bis((2-oxoyl-3-(dibenzo-1H-pyrrole-1-yl)-5-(methyl)phenyl)-2-phenoxymethyl)-1,4-butanediylhafnium (IV) dimethyl, bis((2-oxoyl-3-(dibenzo-1H-pyrrole-1-yl)-5-(methyl)phenyl)-2-phenoxymethyl)-1,4-butanediylhafnium (IV) dichloride, bis((2-oxoyl-3-(dibenzo-1H-pyrrole-1-yl)-5-(methyl)phenyl)-2-phenoxymethyl)-1,4-butanediylhafnium (IV) dibenzyl, bis((2-oxoyl-3-(1,2,3,4,6,7,8,9-octahydroanthracen-5-yl)-5-(methyl)phenyl)-2-phenoxy)-2,4-pentanediylhafnium (IV) dimethyl, bis((2-oxoyl-3-(1,2,3,4,6,7,8,9-octahydroanthracen-5-yl)-5-(methyl)phenyl)-2-phenoxy)-2,4-pentanediylhafnium (IV) dichloride, bis((2-oxoyl-3-(1,2,3,4,6,7,8,9-octahydroanthracen-5-yl)-5-(methyl)phenyl)-2-phenoxy)-2,4-pentanediylhafnium (IV) dibenzyl, bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-(dibenzo-1H-pyrrole-1-yl)-5-(methyl)phenyl)-2-phenoxy)-2,4-pentanediylhafnium (IV) dichloride, bis((2-oxoyl-3-(dibenzo-1H-pyrrole-1-yl)-5-(methyl)phenyl)-2-phenoxy)-2,4-pentanediylhafnium (IV) dibenzyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dimethyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dichloride, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dibenzyl, bis((2-oxoyl-3-(dibenzo-1H-pyrrole-1-yl)-5-(methyl)phenyl)-2-phenoxymethyl)-methylenetrans-1,2-cyclohexanediylhafnium (IV) dimethyl, bis((2-oxoyl-3-(dibenzo-1H-pyrrole-1-yl)-5-(methyl)phenyl)-2-phenoxymethyl)-methylenetrans-1,2-cyclohexanediylhafnium (IV) dichloride, and bis((2-oxoyl-3-(dibenzo-1H-pyrrole-1-yl)-5-(methyl)phenyl)-2-phenoxymethyl)-methylenetrans-1,2-cyclohexanediylhafnium (IV) dibenzyl, bis((2-oxoyl-3-(dibenzo-1H-pyrrole-1-yl)phenyl)-2-phenoxy)-1,3-propylhafnium (IV) dibenzyl, bis((2-oxoyl-3-(dibenzo-1H-pyrrole-1-yl)phenyl)-2-phenoxy)-1,4-n-butylhafnium (IV) dimethyl, bis((2-oxoyl-3-(dibenzo-1H-pyrrole-1-yl)phenyl)-2-phenoxy)-1,4-n-butylhafnium (IV) dibenzyl, bis((2-oxoyl-3-(3,6-bis(1,1-dimethylethyl)-9H-carbazolyl)phenyl)-2-phenoxy)-1,3-propylhafnium (IV) dimethyl, bis((2-oxoyl-3-(3,6-bis(1,1-dimethylethyl)-9H-carbazolyl)phenyl)-2-phenoxy)-1,3-propylhafnium (IV) dibenzyl, bis((2-oxoyl-3-(3,6-bis(1,1-dimethylethyl)-9H-carbazolyl)phenyl)-2-phenoxy)-1,4-n-butylhafnium (IV) dimethyl, bis((2-oxoyl-3-(3,6-bis(1,1-dimethylethyl)-9H-carbazolyl)phenyl)-2-phenoxy)-1,4-n-butylhafnium (IV) dibenzyl, bis((2-oxoyl-3-(4-methoxy-3,5-bis(1,1-dimethylethyl)phenyl)phenyl)-2-phenoxy)-1,4-n-butylhafnium (IV) dimethyl, bis((2-oxoyl-3-(4-methoxy-3,5-bis(1,1-dimethylethyl)phenyl)phenyl)-2-phenoxy)-1,4-n-butylhafnium (IV) dibenzyl, bis((2-oxoyl-3-(dibenzo-1H-pyrrole-1-yl)phenyl)-2-phenoxy)-1,2-ethylhafnium (IV) dimethyl, bis((2-oxoyl-3-(dibenzo-1H-pyrrole-1-yl)phenyl)-2-phenoxy)-1,2-ethylhafnium (IV) dibenzyl, bis((2-oxoyl-3-(dibenzo-1H-pyrrole-1-yl)phenyl)-2-phenoxy)-1,3-propylhafnium (IV) dimethyl; preferably bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-dibenzo-1H-pyrrole-1-yl)-5-(methyl)phenyl)-2-phenoxy)-2,4-pentanediylhafnium (IV) dichloride; or a zirconium complex of a polyvalent aryloxyether selected from the group: bis((2-oxoyl-3-(dibenzo-1 H-pyrrole-1-yl)-5-(methyl)phenyl)-2-phenoxy)-2,4-pentanediylzirconium (IV) dimethyl, bis((2-oxoyl-3-(dibenzo-1H-pyrrole-1-yl)-5-(methyl)phenyl)-2-phenoxy)-2,4-pentanediylzirconium (IV) dichloride, bis((2-oxoyl-3-(1,2,3,4,6,7,8,9-octahydroanthracen-5-yl)-5-(methyl)phenyl)-2-phenoxy)-1,3-propanediylzirconium (IV) dimethyl, bis((2-oxoyl-3-(1,2,3,4,6,7,8,9-octahydroanthracen-5-yl)-5-(methyl)phenyl)-2-phenoxy)-1,3-propanediylzirconium (IV) dichloride, bis((2-oxoyl-3-(1,2,3,4,6,7,8,9-octahydroanthracen-5-yl)-5-(methyl)phenyl)-2-phenoxy)-1,3-propanediylzirconium (IV) dibenzyl, bis((2-oxoyl-3-(dibenzo-1H-pyrrole-1-yl)-5-(methyl)phenyl)-2-phenoxy)-1,3-propanediylzirconium (IV) dimethyl, bis((2-oxoyl-3-(dibenzo-1H-pyrrole-1-yl)-5-(methyl)phenyl)-2-phenoxy)-1,3-propanediylzirconium (IV) dichloride, bis((2-oxoyl-3-(dibenzo-1H-pyrrole-1-yl)-5-(methyl)phenyl)-2-phenoxy)-1,3-propanediylzirconium (IV) dibenzyl, bis((2-oxoyl-3-(1,2,3,4,6,7,8,9-octahydroanthracen-5-yl)-5-(methyl)phenyl)-2-phenoxymethyl)-1,4-butanediylzirconium (IV) dimethyl, bis((2-oxoyl-3-(1,2,3,4,6,7,8,9-octahydroanthracen-5-yl)-5-(methyl)phenyl)-2-phenoxymethyl)-1,4-butanediylzirconium (IV) dichloride, bis((2-oxoyl-3-(1,2,3,4,6,7,8,9-octahydroanthracen-5-yl)-5-(methyl)phenyl)-2-phenoxymethyl)-1,4-butanediylzirconium (IV) dibenzyl, bis((2-oxoyl-3-(dibenzo-1H-pyrrole-1-yl)-5-(methyl)phenyl)-2-phenoxymethyl)-1,4-butanediylzirconium (IV) dimethyl, bis((2-oxoyl-3-(dibenzo-1H-pyrrole-1-yl)-5-(methyl)phenyl)-2-phenoxymethyl)-1,4-butanediylzirconium (IV) dichloride, bis((2-oxoyl-3-(dibenzo-1H-pyrrole-1-yl)-5-(methyl)phenyl)-2-phenoxymethyl)-1,4-butanediylzirconium (IV) dibenzyl, bis((2-oxoyl-3-(1,2,3,4,6,7,8,9-octahydroanthracen-5-yl)-5-(methyl)phenyl)-2-phenoxy)-2,4-pentanediylzirconium (IV) dimethyl, bis((2-oxoyl-3-(1,2,3,4,6,7,8,9-octahydroanthracen-5-yl)-5-(methyl)phenyl)-2-phenoxy)-2,4-pentanediylzirconium (IV) dichloride, bis((2-oxoyl-3-(1,2,3,4,6,7,8,9-octahydroanthracen-5-yl)-5-(methyl)phenyl)-2-phenoxy)-2,4-pentanediylzirconium (IV) dibenzyl, bis((2-oxoyl-3-(dibenzo-1H-pyrrole-1-yl)-5-(methyl)phenyl)-2-phenoxy)-2,4-pentanediylzirconium (IV) dibenzyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dimethyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dichloride, bis((2-oxoyl-3-(1,2,3,4,6,7,8,9- octahydroanthracen-5-yl)-5-(methyl)phenyl)-2-phenoxymethyl) -methylenetrans-1,2-cyclohexanediylzirconium (IV) dibenzyl, bis((2-oxoyl-3-(dibenzo-1H-pyrrole-1-yl)-5-(methyl)phenyl)-2-phenoxymethyl)-methylenetrans -1,2-cyclohexanediylzirconium (IV) dimethyl, bis((2-oxoyl-3-(dibenzo-1H-pyrrole-1-yl)-5-(methyl)phenyl)-2-phenoxymethyl)-methylenetrans-1,2-cyclohexanediylzirconium (IV) dichloride, and bis((2-oxoyl-3-(dibenzo-1H-pyrrole-1-yl)-5-(methyl) phenyl)-2-phenoxymethyl)-methylenetrans-1,2-cyclohexanediylzirconium (IV) dibenzyl, bis((2-oxoyl-3-(4-methoxy-3,5-bis(1,1-dimethylethyl) phenyl)phenyl)-2-phenoxy)-1,4-n-butylzirconium (IV) dimethyl, bis((2-oxoyl-3-(4-methoxy-3,5-bis(1,1-dimethylethyl)phenyl)phenyl)-2-phenoxy)-1,4-n-butylzirconium (IV) dibenzyl, bis((2-oxoyl-3-(dibenzo-1H-pyrrole-1-yl)phenyl)-2-phenoxy)-1,2-ethylzirconium (IV) dimethyl, bis((2-oxoyl-3-(dibenzo-1H-pyrrole-1-yl)phenyl)-2-phenoxy)-1,2-ethylzirconium (IV) dibenzyl, bis((2-oxoyl-3-(dibenzo-1H-pyrrole-1-yl) phenyl)-2-phenoxy)-1,3-propylzirconium (IV) dimethyl, bis((2-oxoyl-3-(dibenzo-1H-pyrrole-1-yl)phenyl)-2-phenoxy)-1,3-propylzirconium (IV) dibenzyl, bis((2-oxoyl-3-(dibenzo-1H-pyrrole-1-yl)phenyl)-2-phenoxy)-1,4-n-butylzirconium (IV) dimethyl, bis((2-oxoyl-3-(dibenzo-1H-pyrrole-1-yl)phenyl)-2-phenoxy)-1,4-n-butylzirconium (IV) dibenzyl, bis((2-oxoyl-3-(3,6-bis(1,1-dimethylethyl)-9H-carbazolyl)phenyl)-2-phenoxy)-1,3-propylzirconium (IV) dimethyl, bis((2-oxoyl-3-(3,6-bis(1,1-dimethylethyl)-9H-carbazolyl)phenyl)-2-phenoxy)-1,3-propylzirconium (IV) dibenzyl, bis((2-oxoyl-3-(3,6-bis(1,1-dimethylethyl)-9H-carbazolyl)phenyl)-2-phenoxy)-1,4-n-butylzirconium (IV) dimethyl, bis((2-oxoyl-3-(3,6-bis(1,1-dimethylethyl)-9H-carbazolyl)phenyl)-2-phenoxy)-1,4-n-butylzirconium (IV) dibenzyl; preferably bis((2-oxoyl-3-(dibenzo-1H-pyrrole-1-yl)-5-(methyl)phenyl)-2-phenoxy)-2,4-pentanediylzirconium (IV) dimethyl, bis((2-oxoyl-3-(dibenzo-1H-pyrrole-1-yl)-5-(methyl)phenyl)-2-phenoxy)-2,4-pentanediylzirconium (IV) dichloride; and
   a co-catalyst selected from the group: MAO, DMAO, MMAO, SMAO or ammonium salts or trityl salts of fluorated tetraarylborates, preferably MAO, MMAO, and
   optionally, a scavenger selected from the group: trimethyl aluminum, triethyl aluminum, triisobutyl aluminum , trihexyl aluminum, trioctyl aluminum and
   optionally, a chain transfer agent selected from the group: dihydrogen or AlR¹⁰₃, BR¹⁰₃ or MgR¹⁰₂ or ZnR¹⁰₂, where each R¹⁰ is independently selected from hydrogen or hydrocarbyl.
b) A deprotection step where the product obtained by step a) is treated with water or a Brønsted acid or base solution, capable to abstract the residue derived from the protecting agent from the protected functionalized olefin copolymer to obtain the functionalized polyolefin.

In an embodiment, after the deprotection step (b), a recovery step (c) of the functionalized polyolefin is carried out by a deashing step in order to separate residues of the protective species, such as aluminum oxides and hydroxides, from the functionalized polyolefin.

In an embodiment, the at least one olefin monomer is selected from the group consisting of ethylene, propylene, 1-butene, 3-methyl-1-butene, 1-pentene, 4-methyl-1-pentene, 1-hexene, vinyl cyclohexane, 1-octene, norbornene, vinylidene-norbornene, ethylidene-norbornene, or wherein the at least one olefin monomer is propylene and/or 1-hexene.

In an embodiment, the at least one the functionalized olefin monomers is selected from the group comprising: allyl alcohol, 3-buten-1-ol, 3-buten-2-ol, 3-buten-1,2-diol, 5-hexene-1-ol, 5-hexene-1,2-diol, 7-octen-1-ol, 7-octen-1,2-diol, 9-decen-1-ol, 10-undecene-1-ol, 5-norbornene-2-methanol, 3-butenoic acid, 4-pentenoic acid, 10-undecenoic acid, 5-norbornene-2-carboxylic acid, 5-norbornene-2-acetic acid, 5-hexen-1-thiol, 10-undecen-1-thiol, N-propyl-5-hexen-1-amine, N-isopropyl-5-hexen-1-amine and N-cyclohexyl-5-hexen-1-amine, 4-penten-2-amine, 3-methyl-4-penten-2-amine, 3-butene-1-thiol, 5-hexene-1-thiol, preferably 3-buten-1-ol, 5-hexene-1-ol, 5-norbornene-2-methanol, 3-butenoic acid, 4-pentenoic acid, 5-norbornene-2-carboxylic acid.

In an embodiment, the protection step is performed by reacting a functionalized olefin monomer with an aluminum trialkyl, where the aluminum trialkyl is selected from the group comprising: triethyl aluminum, triisobutyl aluminum, trihexyl aluminum, trioctyl aluminum, or with a dialkyl aluminum alkoxide, R¹¹OAl(R¹²)₂ where R¹¹=methyl, ethyl, n-propyl, isopropyl, n-butyl, isobutyl, tert-butyl, cyclohexyl and R¹²=ethyl, isobutyl, n-hexyl, n-octyl.

In an embodiment, the amount of the functionalized olefin monomers in the functionalized polyolefin obtained from step b) is from 0.01 to 20 mol %, preferably from 0.02 to 15 mol % or from 0.05 to 10 mol %, or from 0.1 to 5 mol %, more preferably 0.02-2 mol %, with respect to the total molar amount of the olefin monomers and the functionalized olefin monomers in the functionalized polyolefin.

In an embodiment, a first and a second olefin monomer are used to be copolymerized with the at least one protected functionalized olefin monomer, wherein the first and second olefin monomer are different and wherein the amount of the first olefin monomer is from 20 to 80 mol % and the amount of second olefin monomer is from 80 to 20 mol %, based on the total molar amount of first and second olefin monomer.

In an embodiment, at least one of the olefin monomers is propylene used in an amount of at least wt %, preferably at least 60 wt %, more preferably at least >70 wt %, most preferably at least wt % with respect to the total weight of the olefin monomers and the functionalized olefin monomers.

In an embodiment, the first olefin is propylene or ethylene and the second olefin is 1-hexene, 1-octene or norbornene, or the first olefin is propylene and the second olefin is ethylene.

In an embodiment the deprotection step is carried out with water.

In an embodiment the deprotection step is carried out with a Brønsted acid, preferably HCl.

In an embodiment the deprotection step is carried out with a base, preferably Bronsted base, more preferably NaOH.

In an embodiment a deashing step can be performed after the deprotection step.

In an embodiment a functionalized copolymer is obtained, preferably a copolymer in which the first monomer is selected from the group comprising ethylene and propylene and the second monomer is selected from the group comprising 3-buten-1-ol, 5-hexen-1-ol and 5-norbornene-2-methanol, more preferably the functionalized copolymer is poly(propylene-co-5-hexen-1-ol), poly(ethylene-co-5-hexen-1-ol), poly(propylene-co-3-buten-1-ol), poly(ethylene-co-3-buten-1-ol) or poly(ethylene-co-5-norbornene-2-methanol).

In an embodiment a functionalized terpolymer is obtained, preferably a terpolymer in which the first monomer is selected from the group comprising ethylene and propylene, the second monomer is selected from the group comprising propylene, 1-hexene, 1-octene and norbornene and the third monomer is selected from the group comprising 3-buten-1-ol, 5-hexen-1-ol and 5-norbornene-2-methanol, more preferably the functionalized terpolymer is poly(propylene-co-ethylene-co-5-hexen-1-ol), poly(propylene-co-1-hexene-co-5-hexen-1-ol), poly(ethylene-co- norbornene-co-5-hexen-1-ol), poly(ethylene-co-1-octene-co-5-hexen-1-ol), poly(propylene-co-ethylene-co-3-buten-1-ol), poly(propylene-co-1-hexene-co-3-buten-1-ol), poly(ethylene-co-1-octene-co-3-buten-1-ol), poly(ethylene-co-norbornene-co-3-buten-1-ol) or poly(ethylene-co-norbornene-co-5-norbornene-2-methanol).

A second aspect of the invention is the use of a functionalized polyolefin obtained by a process according to the invention in an article, compatibilizer or adhesive, adhesion improver in coating or paint.

A third aspect of the invention is the use of functionalized polyolefin obtained by a process according to the invention in a foam article in which the aluminum species such as aluminum oxide hydroxide has not been separated from the functionalized polyolefin.

A forth aspect of the invention is the use, in a solution process, of a catalyst system comprising a hafnium complex of a polyvalent aryloxyether and a co-catalyst selected from the group: MAO, DMAO, MMAO, SMAO and ammonium salts or trityl salts of fluorated tetraarylborates, in order to obtain a functionalized polyolefin.

Finally a last aspect of the invention is a functionalized olefin obtainable by the process of the invention preferably:
Functionalized olefin copolymer having:
   M_{w} range 40 to 300 kg/mol
   Mₙ range of 20 to 150 kg/mol
   Crystallinity>30%
   Melting point between 100-155° C.
   Randomly distributed hydroxyl, carboxylic acid, amine or thiol functionalities
   A functional comonomer content of 0.05-10 mol %, preferably 0.1-5 mol %, more preferably 0.02-2 mol %
Functionalized olefin terpolymer having:
   M_{w} range 40 to 300 kg/mol
   Mₙ range 20 to 150 kg/mol
   Crystallinity range 0-30%
   Melting point between 40-120° C.
   A comonomer content of 0.5-20 mol %, preferably 2-18 mol %, more preferably 5-15 mol %
   Randomly distributed hydroxyl, carboxylic acid, amine or thiol functionalities
   A functional comonomer content of 0.05-10 mol %, preferably 0.1-5 mol %, more preferably 0.02-2 mol %

In an embodiment, the functionalized olefin comprises at least 0.1 more preferably at least 0.5 wt % and maximum 5 wt % of aluminum.

### DETAILED DESCRIPTION

The process for solution copolymerization to obtain a functionalized polyolefin according to the invention comprises at least the two following steps in which:

### Step a)

A copolymerization step of at least one olefin monomer and at least one protected functionalized olefin monomer in the presence of the following components:

### Olefin Monomer

The olefin monomer is selected from the group comprising: ethylene, propylene, 1-butene, 3-methyl-1-butene, 1-pentene, 4-methyl-1-pentene, 1-hexene, vinyl cyclohexane, 1-octene, norbornene, vinylidene-norbornene, ethylidene-norbornene, or a combination of therefore.

In another embodiment the at least one olefin monomer is propylene, in particular in an amount of at least 50 wt %, preferably at least 60 wt %, more preferably at least >70 wt %, most preferably at least 80 wt % with respect to the total weight of the olefin monomers and the functionalized olefin monomers.

In another embodiment the at least one olefin monomer is ethylene, in particular in an amount of at least 50 wt %, preferably at least 60 wt %, more preferably at least >70 wt %, most preferably at least 80 wt % with respect to the total weight of the olefin monomers and the functionalized olefin monomers.

The polymerization step may use one type of olefin monomer or two or more types of olefin monomer.

In another embodiment, the first and second olefin monomer are different and the amount of the first olefin monomer is from 20 to 80 mol % and the amount of second olefin monomer is from 80 to 20 mol %, based on the total molar amount of first and second olefin monomer.

In another embodiment, the first olefin is ethylene and the second olefin is 1-octene.

In another embodiment, the first olefin is ethylene and the second olefin is norbornene.

In another embodiment, the first olefin is propylene and the second olefin is 1-hexene.

In another embodiment, the first olefin is propylene and the second olefin is ethylene.

### Protected Functionalized Olefin Monomer

The protected functionalized olefin monomer has the following structure according to Formula (III) or (IIIbis)

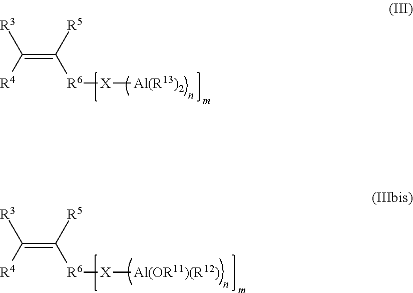

wherein R³, R⁴, and R⁵ are each independently selected from the group consisting of H and hydrocarbyl with 1 to 16 carbon atoms,
wherein n is 1 or 2,
when n=1, X is selected from —O—, —S— or —CO₂— and R⁷ is H, or
when n=2, X is N and
   Wherein R¹¹=methyl, ethyl, n-propyl, isopropyl, n-butyl, isobutyl, tert-butyl, cyclohexyl,
   R¹²=ethyl, isobutyl, n-hexyl, n-octyl, and
   R¹³=Hydrogen, methyl, ethyl, n-propyl, isopropyl, n-butyl, isobutyl, tert-butyl, cyclohexyl,
   Wherein m is an entire number between 1 and 10, preferably 1 or 2. and is a reaction product of:
a functionalized olefin monomer according to Formula (I)

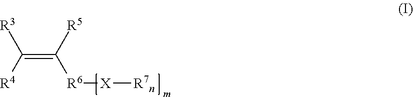

wherein R³, R⁴, and R⁵ are each independently selected from the group consisting of H and hydrocarbyl with 1 to 16 carbon atoms,
wherein R⁶—[X—(R⁷)ₙ]ₘ is a polar functional group containing m heteroatom-containing functionalities X—(R⁷)ₙ, in which m is an entire number between 1 and 10, preferably 1 or 2, wherein
when n=1, X is selected from —O—, —S— or —CO₂— and R⁷ is H, or
when n=2, X is N and at least one R⁷ is H and the other R⁷ is selected from the group consisting of H and a hydrocarbyl group with 1 to 16 carbon atoms,
   wherein R⁶ is either —C(R⁸)(R⁹)— or a plurality of —C(R⁸)(R⁹)— groups, wherein R⁸, and R⁹ are each independently selected from the group consisting of H or hydrocarbyl with 1 to 16 carbon atoms and R⁶ comprises 1 to 10 carbon atoms,
   wherein X is attached to either the main chain and/or side chain of R⁶,
   wherein R⁴ and R⁶ may together form a ring structure that is functionalized with one or multiple X—(R⁷)ₙ.
   Preferably, X is selected from —O— or —CO₂—.
   and
a protecting agent according to one of the Formula (II) or (II bis)

AlR¹³₃ (II)
where R¹³=hydrogen, methyl, ethyl, n-propyl, isopropyl, n-butyl, isobutyl, tert-butyl, cyclohexyl,

R¹¹OAl(R¹²)₂ (IIbis)

where R¹¹=methyl, ethyl, n-propyl, isopropyl, n-butyl, isobutyl, tert-butyl, cyclohexyl and R¹²=ethyl, isobutyl, n-hexyl, n-octyl during a protection step.

In a preferred embodiment, the functionalized olefin monomer according to Formula I is a hydroxyl- or carboxylic acid-bearing α-olefin or hydroxyl- or carboxylic acid-functionalized ring-strained cyclic olefin monomer, preferably a hydroxyl, a dihydroxyl or carboxylic acid α-olefin monomer.

Hydroxyl-bearing functionalized α-olefin monomers may correspond for example to Formula I wherein R³, R⁴ and R⁵ are each H and wherein X is —O— and wherein R⁶ is either —C(R⁸)(R⁹)— or a plurality of —C(R⁸)(R⁹)— groups, wherein R⁸ and R⁹ are each independently selected from the group consisting of H or hydrocarbyl with 1 to 16 carbon atoms. Examples of R⁶ groups are —(CH₂)₉— and —(CH₂)₄—.

Further examples of the hydroxyl-functionalized a-olefin monomer include, but are not limited to allyl alcohol, 3-buten-1-ol, 3-buten-2-ol, 3-buten-1,2-diol, 5-hexene-1-ol, 5-hexene-1,2-diol, 7-octen-1-ol, 7-octen-1,2-diol, 9-decen-1-ol, 10-undecene-1-ol, preferably 3-buten-1-ol, 5-hexene-1-ol.

Even further examples of functionalized olefin monomer include hydroxyl-functionalized ring-strained cyclic olefins (also called internal olefins), which may be for example typically hydroxyl-functionalized norbornenes, preferably 5-norbornene-2-methanol. They correspond to Formula I wherein R³ and R⁵ are H and R⁴ and R⁶ together for a ring structure that is functionalized with X—H, wherein X is —O—.

Carboxylic acid-bearing functionalized olefin monomers may for example correspond to Formula I wherein R³ and R⁵ are each H and wherein X is —CO₂— and wherein R⁶ is either —C(R⁸)(R⁹)— or a plurality of —C(R⁸)(R⁹)— groups, wherein R⁸ and R⁹ are each independently selected from the group consisting of H or hydrocarbyl with 1 to 16 carbon atoms. An example of an R⁶ group is —(CH₂)₈—. Preferred acid functionalized olefin monomers may be selected from the group of 3-butenoic acid, 4-pentenoic acid, 5-norbornene-2-carboxylic acid.

Thiol-bearing functionalized olefin monomers may for example correspond to Formula I wherein R³ and R⁵ are each H and wherein X is —S— and wherein R⁶ is either —C(R⁸)(R⁹)— or a plurality of —C(R⁸)(R⁹)— groups, wherein R⁸ and R⁹ are each independently selected from the group consisting of H or hydrocarbyl with 1 to 16 carbon atoms. Examples of R⁶ groups are —(CH₂)₉— and —(CH₂)₄—. Preferred thiol functionalized olefin monomers may be selected from the group of 5-hexen-1-thiol, 10-undecen-1-thiol.

Amine-bearing functionalized olefin monomers may for example correspond to Formula I wherein R³ and R⁵ are each H and wherein X is —N(H)R⁷— and wherein R⁶ is either —C(R⁸)(R⁹)— or a plurality of —C(R⁸)(R⁹)— groups, wherein R⁸, and R⁹ are each independently selected from the group consisting of H or hydrocarbyl with 1 to 16 carbon atoms and wherein R⁷ is H or hydrocarbyl. An examples of an R⁶ group is —(CH₂)₄—. Preferred amine functionalized olefin monomers may be selected from the group of N-methyl-5-hexen-1-amine, N-ethyl-5-hexen-1-amine, N-propyl-5-hexen-1-amine, N-isopropyl-5-hexen-1-amine, N-cyclohexyl-5-hexen-1-amine.

In an embodiment 2 different monomers are used in order to obtain a copolymer, preferably a copolymer in which the first monomer is selected from the group comprising ethylene and propylene and the second monomer is selected from the group comprising 3-buten-1-ol, 5-hexen-1-ol and 5-norbornene-2-methanol, more preferably the functionalized copolymer is poly(propylene-co-5-hexen-1-ol), poly(ethylene-co-5-hexen-1-ol), poly(propylene-co-3-buten-1-ol), poly(ethylene-co-3-buten-1-ol) or poly(ethylene-co-5-norbornene-2-methanol).

In another embodiment 3 different monomers are used in order to obtain a terpolymer, preferably a terpolymer in which the first monomer is selected from the group comprising ethylene and propylene, the second monomer is selected from the group comprising propylene, 1-hexene, 1-octene and norbornene and the third monomer is selected from the group comprising 3-buten-1-ol, 5-hexen-1-ol and 5-norbornene-2-methanol, more preferably the functionalized terpolymer is poly(propylene-co-ethylene-co-5-hexen-1-ol), poly(propylene-co-1-hexene-co-5-hexen-1-ol), poly(ethylene-co-norbornene-co-5-hexen-1-ol), poly(ethylene-co-1-octene-co-5-hexen-1-ol), poly(propylene-co-ethylene-co-3-buten-1-ol), poly(propylene-co-1-hexene-co-3-buten-1-ol), poly(ethylene-co-1-octene-co-3-buten-1-ol), poly(ethylene-co-norbornene-co-3-buten-1-ol) or poly(ethylene-co-norbornene-co-5-norbornene-2-methanol).

It is preferred that the amount of the functionalized olefin monomers in the functionalized polyolefin obtained from step b) is from 0.01 to 20 mol %, preferably from 0.02 to 15 mol % or from 0.05 to 10 mol %, or from 0.1 to 5 mol %, more preferably 0.02 to 2 mol %, with respect to the total molar amount of the olefin monomers and the functionalized olefin monomers in the functionalized polyolefin.

### Protecting Agent

The hydrogen atoms directly bound to X in the functionalized olefin monomer has a Bronsted acidic nature poisonous to the highly reactive catalyst. A protecting agent is used, which can react with the acidic hydrogen and binds to the monomer comprising the polar group. This reaction will prevent a reaction of the acidic polar group (—X—H) with the catalyst and coordination of the polar group (—X—) to the catalyst.

Examples of protecting agents are silyl halides, trialkyl aluminum complexes, dialkyl aluminum alkoxide complexes, dialkyl magnesium complexes, dialkyl zinc complexes or trialkyl boron complexes.

In the process of the invention it is preferred that the protecting agent is selected from trialkyl aluminum complexes selected from the group comprising: triethyl aluminum, triisobutyl aluminum, trihexyl aluminum, trioctyl aluminum, or with a dialkyl aluminum alkoxide, R¹¹OAl(R¹²)₂ where where R¹¹=methyl, ethyl, n-propyl, isopropyl, n-butyl, isobutyl, tert-butyl, cyclohexyl and R¹²=ethyl, isobutyl, n-hexyl, n-octyl, or a combination of a trialkyl aluminum and a dialkyl aluminum alkoxide. The most preferred protecting agent is triethyl aluminum.

Preferably, the protecting agent is according to one of the Formula (II) or (IIbis)

AlR¹³₃ (II)

where R¹³=Hydrogen, methyl, ethyl, n-propyl, isopropyl, n-butyl, isobutyl, tert-butyl, cyclohexyl,

R¹¹OAl(R¹²)₂ (IIbis)

where R¹¹=methyl, ethyl, n-propyl, isopropyl, n-butyl, isobutyl, tert-butyl, cyclohexyl and R¹²=ethyl, isobutyl, n-hexyl, n-octyl

Surprisingly, triethyl aluminum does not lead to severe chain transfer and does not inhibit the catalyst comprising the ligand-metal complex as describe above. This feature allows to use triethyl aluminum instead of triisobutyl aluminum, which is a great cost benefit.

In order to obtain the protected functionalized olefin monomer, a preliminary protection step is performed prior to the copolymerization step of the functionalized olefin monomer.

In an embodiment, the protection step in order to obtain a protected functionalized olefin monomer according to Formula (I) may be performed by an alumination reaction of a hydroxyl or carboxylic acid functionalized olefin monomer by reacting it with a trialkyl aluminum, for example triethyl aluminum, or a dialkyl aluminum alkoxide, for example diethyl aluminum ethoxide, or the combination of a trialkyl aluminum and dialkyl aluminum alkoxide, for example triethyl aluminum and diethyl aluminum ethoxide.

The molar amount of the protecting agent preferably is at least the same molar amount as the functional group in the functionalized olefin monomer. Preferably, the molar amount of protecting agent is at least 10 mol % higher than the amount of functionalized olefin monomer, or at least 20 mol % higher. Typically the amount of protecting agent is less than 250 mol % of functionalized olefin monomer. In some occasions higher amounts may be used or may be necessary.

### Catalyst System Suitable for the Process According to the Invention.

The process according to the invention is performed in the presence of a suitable catalyst system which comprise at least:
A catalyst
A co-catalyst
Optionally a scavenger
Optionally a chain transfer

### Catalyst

The catalyst is a ligand-metal complexes having a bridged bis-bi-aryl structure. In particular, the ligands are dianionic chelating ligands that can occupy up to four coordination sites of a metal precursor atom and more specifically have a bridged-bis-bi-aryl structure.

The metal-ligand complexes used in this invention can be characterized by the general formula: (4,O)MLn′ (VI) where (4,O) is a dianionic ligand having at least 4 atoms that are oxygen and chelating to the metal M at 4 coordination sites through oxygen atoms with two of the bonds between the oxygen and the metal being covalent in nature and two of the bonds being dative in nature; M is a metal selected from the group consisting of group 4 of the Periodic Table of Elements, more specifically, from Hf or Zr, preferentially Hf; L is independently selected from the group consisting of halide (F, Cl, Br, I), optionally substituted alkyl, alkenyl, alkynyl, heteroalkyl, heteroalkenyl, heteroalkynyl, aryl, heteroaryl, alkoxyl, aryloxyl, silyl, boryl, phosphino, amino, alkylthio, arylthio, nitro, hydrido, borohydride, allyl, diene, phosphine, carboxylates, 1,3-dionates, oxalates, carbonates, nitrates, sulphates, ethers, thioethers and combinations thereof; and optionally two or more L groups may be linked together in a ring structure; n′ is 1, 2, 3, or 4.

The metal precursors may be monomeric, dimeric or higher orders thereof. Specific examples of suitable hafnium and zirconium precursors include, but are not limited to HfCl₄, Hf(CH₂Ph)₄, Hf(CH₂CMe₃)₄, Hf(CH₂SiMe₃)₄, Hf(CH₂Ph)₃Cl, Hf(CH₂CMe₃)₃Cl, Hf(CH₂SiMe₃)₃Cl, Hf(CH₂Ph)₂Cl₂, Hf(CH₂CMe₃)₂Cl₂, Hf(CH₂SiMe₃)₂Cl₂, Hf(NMe₂)₄, Hf(NEt₂)₄, and Hf(N(SiMe₃)₂)₂Cl₂;

ZrCl₄, Zr(CH₂Ph)₄, Zr(CH₂CMe₃)₄, Zr(CH₂SiMe₃)₄, Zr(CH₂Ph)₃Cl, Zr(CH₂CMe₃)₃Cl, Zr(CH₂SiMe₃)₃Cl, Zr(CH₂Ph)₂Cl₂, Zr(CH₂CMe₃)₂Cl₂, Zr(CH₂SiMe₃)₂Cl₂, Zr(NMe₂)₄, Zr(NEt₂)₄, Zr(NMe₂)₂Cl₂, Zr(NEt₂)₂Cl₂, and Zr(N(SiMe₃)₂)₂Cl₂.

Lewis base adducts of these examples are also suitable as metal precursors, for example, ethers, amines, thioethers, phosphines and the like are suitable as Lewis bases.

In still other embodiments, the metal-ligand complexes of this invention may be characterized by the general formula:

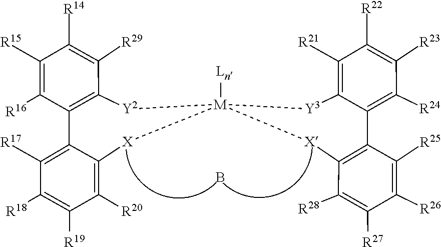

### Wherein

R¹⁴, R¹⁵, R¹⁶, R¹⁷, R¹⁸, R¹⁹, R²⁰, R²¹, R²², R²³, R²⁴, R²⁵, R²⁶, R²⁷, R²⁸ and R²⁹ are independently selected from the group consisting of hydride, halide, and optionally substituted hydrocarbyl, heteroatom-containing hydrocarbyl, alkoxy, aryloxy, silyl, boryl, phosphino, amino, alkylthio, arylthio, thioxy, seleno, nitro, and combinations thereof; optionally two or more R groups can combine together into ring structures, with such ring structures having from 3 to 100 atoms in the ring not counting hydrogen atoms
M is a metal Hf or Zr,
L is a moiety that forms a covalent, dative or ionic bond with M; and n′ is 1, 2, 3 or 4.
X, X′, Y² and Y³ are oxygen atoms,
B is a bridging group having from one to 50 atoms not counting hydrogen atoms, preferentially B is a propane bridge

In a preferred embodiment ligand-metal complex must be a hafnium or zirconium complex of a polyvalent aryloxyether, selected from the group comprising at least: bis((2-oxoyl-3-(1,2,3,4,6,7,8,9-octahydroanthracen-5-yl)-5-(methyl)phenyl)-2-phenoxy)-1,3-propanediylhafnium (IV) dimethyl, bis((2-oxoyl-3-(1,2,3,4,6,7,8,9-octahydroanthracen-5-yl)-5-(methyl)phenyl)-2-phenoxy)-1,3-propanediylhafnium (IV) dichloride, bis((2-oxoyl-3-(1,2,3,4,6,7,8,9-octahydroanthracen-5-yl)-5-(methyl)phenyl)-2-phenoxy)-1,3-propanediylhafnium (IV) dibenzyl, bis((2-oxoyl-3-(dibenzo-1H-pyrrole-1-yl)-5-(methyl)phenyl)-2-phenoxy)-1,3-propanediylhafnium (IV) dimethyl, bis((2-oxoyl-3-(dibenzo-1H-pyrrole-1-yl)-5-(methyl)phenyl)-2-phenoxy)-1,3-propanediylhafnium (IV) dichloride, bis((2-oxoyl-3-(dibenzo-1H-pyrrole-1-yl)-5-(methyl)phenyl)-2-phenoxy)-1,3-propanediylhafnium (IV) dibenzyl, bis((2-oxoyl-3-(1,2,3,4,6,7,8,9-octahydroanthracen-5-yl)-5-(methyl)phenyl)-2-phenoxymethyl)-1,4-butanediylhafnium (IV) dimethyl, bis((2-oxoyl-3-(1,2,3,4,6,7,8,9-octahydroanthracen-5-yl)-5-(methyl)phenyl)-2-phenoxymethyl)-1,4-butanediylhafnium (IV) dichloride, bis((2-oxoyl-3-(1,2,3,4,6,7,8,9-octahydroanthracen-5-yl)-5-(methyl)phenyl)-2-phenoxymethyl)-1,4-butanediylhafnium (IV) dibenzyl, bis((2-oxoyl-3-(dibenzo-1H-pyrrole-1-yl)-5-(methyl)phenyl)-2-phenoxymethyl)-1,4-butanediylhafnium (IV) dimethyl, bis((2-oxoyl-3-(dibenzo-1H-pyrrole-1-yl)-5-(methyl)phenyl)-2-phenoxymethyl)-1,4-butanediylhafnium (IV) dichloride, bis((2-oxoyl-3-(dibenzo-1H-pyrrole-1-yl)-5-(methyl) phenyl)-2-phenoxymethyl)-1,4-butanediylhafnium (IV) dibenzyl, bis((2-oxoyl-3-(1,2,3,4,6,7,8,9-octahydroanthracen-5-yl)-5-(methyl)phenyl)-2-phenoxy)-2,4-pentanediylhafnium (IV) dimethyl, bis((2-oxoyl-3-(1,2,3,4,6,7,8,9-octahydroanthracen-5-yl)-5-(methyl)phenyl)-2-phenoxy)-2,4-pentanediylhafnium (IV) dichloride, bis((2-oxoyl-3-(1,2,3,4,6,7,8,9-octahydroanthracen-5-yl)-5-(methyl)phenyl)-2-phenoxy)-2,4-pentanediylhafnium (IV) dibenzyl, bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-(dibenzo-1H-pyrrole-1-yl)-5-(methyl)phenyl)-2-phenoxy)-2,4-pentanediylhafnium (IV) dichloride, bis((2-oxoyl-3-(dibenzo-1H-pyrrole-1-yl)-5-(methyl)phenyl)-2-phenoxy)-2,4-pentanediylhafnium (IV) dibenzyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dimethyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dichloride, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dibenzyl, bis((2-oxoyl-3-(dibenzo-1H-pyrrole-1-yl)-5-(methyl)phenyl)-2-phenoxymethyl)-methylenetrans-1,2-cyclohexanediylhafnium (IV) dimethyl, bis((2-oxoyl-3-(dibenzo-1H-pyrrole-1-yl)-5-(methyl)phenyl)-2-phenoxymethyl)-methylenetrans-1,2-cyclohexanediylhafnium (IV) dichloride, and bis((2-oxoyl-3-(dibenzo-1H-pyrrole-1-yl)-5-(methyl)phenyl)-2-phenoxymethyl)-methylenetrans-1,2-cyclohexanediylhafnium (IV) dibenzyl, bis((2-oxoyl-3-(dibenzo-1H-pyrrole-1-yl)phenyl)-2-phenoxy)-1,3-propylhafnium (IV) dibenzyl, bis((2-oxoyl-3-(dibenzo-1H-pyrrole-1-yl) phenyl)-2-phenoxy)-1,4-n-butylhafnium (IV) dimethyl, bis((2-oxoyl-3-(dibenzo-1H-pyrrole-1-yl)phenyl)-2-phenoxy)-1,4-n-butylhafnium (IV) dibenzyl, bis((2-oxoyl-3-(3,6-bis(1,1-dimethylethyl)-9H-carbazolyl)phenyl)-2-phenoxy)-1,3-propylhafnium (IV) dimethyl, bis((2-oxoyl-3-(3,6-bis(1,1-dimethylethyl)-9H-carbazolyl)phenyl)-2-phenoxy)-1,3-propylhafnium (IV) dibenzyl, bis((2-oxoyl-3-(3,6-bis(1,1-dimethylethyl)-9H-carbazolyl)phenyl)-2-phenoxy)-1,4-n-butylhafnium (IV) dimethyl, bis((2-oxoyl-3-(3,6-bis(1,1-dimethylethyl)-9H-carbazolyl)phenyl)-2-phenoxy)-1,4-n-butylhafnium (IV) dibenzyl, bis((2-oxoyl-3-(4-methoxy-3,5-bis(1,1-dimethylethyl)phenyl) phenyl)-2-phenoxy)-1,4-n-butylhafnium (IV) dimethyl, bis((2-oxoyl-3-(4-methoxy-3,5-bis(1,1-dimethylethyl) phenyl)phenyl)-2-phenoxy)-1,4-n-butylhafnium (IV) dibenzyl, bis((2-oxoyl-3-(dibenzo-1H-pyrrole-1-yl) phenyl)-2-phenoxy)-1,2-ethylhafnium (IV) dimethyl, bis((2-oxoyl-3-(dibenzo-1H-pyrrole-1-yl)phenyl)-2-phenoxy)-1,2-ethylhafnium (IV) dibenzyl, bis((2-oxoyl-3-(dibenzo-1H-pyrrole-1-yl)phenyl)-2-phenoxy)-1,3-propylhafnium (IV) dimethyl; preferably bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-(dibenzo-1H-pyrrole-1-yl)-5-(methyl)phenyl)-2-phenoxy)-2,4-pentanediylhafnium (IV) dichloride; bis((2-oxoyl-3-(dibenzo-1H-pyrrole-1-yl)-5-(methyl)phenyl)-2-phenoxy)-2,4-pentanediylzirconium (IV) dimethyl, bis((2-oxoyl-3-(dibenzo-1H-pyrrole-1-yl)-5-(methyl)phenyl)-2-phenoxy)-2,4-pentanediylzirconium (IV) dichloride, bis((2-oxoyl-3-(1,2,3,4,6,7,8,9-octahydroanthracen-5-yl)-5-(methyl)phenyl)-2-phenoxy)-1,3-propanediylzirconium (IV) dimethyl, bis((2-oxoyl-3-(1,2,3,4,6,7,8,9-octahydroanthracen-5-yl)-5-(methyl)phenyl)-2-phenoxy)-1,3-propanediylzirconium (IV) dichloride, bis((2-oxoyl-3-(1,2,3,4,6,7,8,9-octahydroanthracen-5-yl)-5-(methyl)phenyl)-2-phenoxy)-1,3-propanediylzirconium (IV) dibenzyl, bis((2-oxoyl-3-(dibenzo-1H-pyrrole-1-yl)-5-(methyl)phenyl)-2-phenoxy)-1,3-propanediylzirconium (IV) dimethyl, bis((2-oxoyl-3-(dibenzo-1H-pyrrole-1-yl)-5-(methyl)phenyl)-2-phenoxy)-1,3-propanediylzirconium (IV) dichloride, bis((2-oxoyl-3-(dibenzo-1H-pyrrole-1-yl)-5-(methyl)phenyl)-2-phenoxy)-1,3-propanediylzirconium (IV) dibenzyl, bis((2-oxoyl-3-(1,2,3,4,6,7,8,9-octahydroanthracen-5-yl)-5-(methyl)phenyl)-2-phenoxymethyl)-1,4-butanediylzirconium (IV) dimethyl, bis((2-oxoyl-3-(1,2,3,4,6,7,8,9-octahydroanthracen-5-yl)-5-(methyl)phenyl)-2-phenoxymethyl)-1,4-butanediylzirconium (IV) dichloride, bis((2-oxoyl-3-(1,2,3,4,6,7,8,9-octahydroanthracen-5-yl)-5-(methyl)phenyl)-2-phenoxymethyl)-1,4-butanediylzirconium (IV) dibenzyl, bis((2-oxoyl-3-(dibenzo-1H-pyrrole-1-yl)-5-(methyl)phenyl)-2-phenoxymethyl)-1,4-butanediylzirconium (IV)dimethyl, bis((2-oxoyl-3-(dibenzo-1H-pyrrole-1-yl)-5-(methyl)phenyl)-2-phenoxymethyl)-1,4-butanediylzirconium (IV) dichloride, bis((2-oxoyl-3-(dibenzo-1H-pyrrole-1-yl)-5-(methyl)phenyl)-2-phenoxymethyl)-1,4-butanediylzirconium (IV) dibenzyl, bis((2-oxoyl-3-(1,2,3,4,6,7,8,9-octahydroanthracen-5-yl)-5-(methyl)phenyl)-2-phenoxy)-2,4-pentanediylzirconium (IV) dimethyl, bis((2-oxoyl-3-(1,2,3,4,6,7,8,9-octahydroanthracen-5-yl)-5-(methyl)phenyl)-2-phenoxy)-2,4-pentanediylzirconium (IV) dichloride, bis((2-oxoyl-3-(1,2,3,4,6,7,8,9-octahydroanthracen-5-yl)-5-(methyl)phenyl)-2-phenoxy)-2,4-pentanediylzirconium (IV) dibenzyl, bis((2-oxoyl-3-(dibenzo-1H-pyrrole-1-yl)-5-(methyl)phenyl)-2-phenoxy)-2,4-pentanediylzirconium (IV) dibenzyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dimethyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dichloride, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dibenzyl, bis((2-oxoyl-3-(dibenzo-1H-pyrrole-1-yl)-5-(methyl) phenyl)-2-phenoxymethyl)-methylenetrans-1,2-cyclohexanediylzirconium (IV) dimethyl, bis((2-oxoyl-3-(dibenzo-1H-pyrrole-1-yl)-5-(methyl)phenyl)-2-phenoxymethyl)-methylenetrans-1,2-cyclohexanediylzirconium (IV) dichloride, and bis((2-oxoyl-3-(dibenzo-1H-pyrrole-1-yl)-5-(methyl)phenyl)-2-phenoxymethyl)-methylenetrans-1,2-cyclohexanediylzirconium (IV) dibenzyl, bis((2-oxoyl-3-(4-methoxy-3,5-bis(1,1-dimethylethyl)phenyl)phenyl)-2-phenoxy)-1,4-n-butylzirconium (IV) dimethyl, bis((2-oxoyl-3-(4-methoxy-3,5-bis(1,1-dimethylethyl)phenyl)phenyl)-2-phenoxy)-1,4-n-butylzirconium (IV) dibenzyl, bis((2-oxoyl-3-(dibenzo-1H-pyrrole-1-yl)phenyl)-2-phenoxy)-1,2-ethylzirconium (IV) dimethyl, bis((2-oxoyl-3-(dibenzo-1H-pyrrole-1-yl)phenyl)-2-phenoxy)-1,2-ethylzirconium (IV) dibenzyl, bis((2-oxoyl-3-(dibenzo-1H-pyrrole-1-yl)phenyl)-2-phenoxy)-1,3-propylzirconium (IV) dimethyl, bis((2-oxoyl-3-(dibenzo-1H-pyrrole-1-yl)phenyl)-2-phenoxy)-1,3-propylzirconium (IV) dibenzyl, bis((2-oxoyl-3-(dibenzo-1H-pyrrole-1-yl)phenyl)-2-phenoxy)-1,4-n-butylzirconium (IV) dimethyl, bis((2-oxoyl-3-(dibenzo-1H-pyrrole-1-yl)phenyl)-2-phenoxy)-1,4-n-butylzirconium (IV) dibenzyl, bis((2-oxoyl-3-(3,6-bis(1,1-dimethylethyl)-9H-carbazolyl)phenyl)-2-phenoxy)-1,3-propylzirconium (IV) dimethyl, bis((2-oxoyl-3-(3,6-bis(1,1-dimethylethyl)-9H-carbazolyl)phenyl)-2-phenoxy)-1,3-propylzirconium (IV) dibenzyl, bis((2-oxoyl-3-(3,6-bis(1,1-dimethylethyl)-9H-carbazolyl)phenyl)-2-phenoxy)-1,4-n-butylzirconium (IV) dimethyl, bis((2-oxoyl-3-(3,6-bis(1,1-dimethylethyl)-9H-carbazolyl)phenyl)-2-phenoxy)-1,4-n-butylzirconium (IV) dibenzyl; (OC-6-33)-[[2,2′″-[1,4-Butanediylbis(oxy-κO)]bis[3″,5′,5″-tris(1,1-dimethylethyl)[1,1′:3′,1″-terphenyl]-2′-olato-κO]](2-)]bis(phenylmethyl)hafnium, (OC-6-33)-[[2,2′″-[1,4-Butanediylbis(oxy-κO)]bis[3″,5′,5″-tris (1,1-dimethylethyl)[1,1′:3′,1″-terphenyl]-2′-olato-κO]](2-)bis(phenylmethyl)zirconium preferably bis((2-oxoyl-3-(dibenzo-1H-pyrrole-1-yl)-5-(methyl)phenyl)-2-phenoxy)-2,4-pentanediylzirconium (IV) dimethyl, bis((2-oxoyl-3-(dibenzo-1H-pyrrole-1-yl)-5-(methyl)phenyl)-2-phenoxy)-2,4-pentanediylzirconium (IV) dichloride;

### Co-Catalyst

The co-catalyst is selected from the group: MAO, DMAO, MMAO, SMAO or ammonium salts or trityl salts of fluorinated tetraarylborates, preferably MAO, MMAO, Trityl tetrakis(pentafluorophenyl)borate dimethylanilinium or tri(alkyl)ammonium tetrakis (pentafluorophenyl)borate such as tri(n-butyl)ammonium tetrakis(pentafluorophenyl)borate, methyl di(alkyl)ammonium tetrakis(pentafluorophenyl)borate. More examples can be found in the review articles of Bochmann Organometallics 2010, 29, 4711-4740 and Chen and Marks Chem. Rev. 2000, 100, 1391-1434.

Methylaluminoxane or MAO as used in the present description may mean: a compound derived from the partial hydrolysis of trimethyl aluminum that serves as a co-catalyst for catalytic olefin polymerization.

Supported methylaluminoxane or SMAO as used in the present description may mean: a methylaluminoxane bound to a solid support.

Depleted methylaluminoxane or DMAO as used in the present description may mean: a methylaluminoxane from which the free trimethyl aluminum has been removed.

Modified methylaluminoxane or MMAO as used in the present description may mean: modified methylaluminoxane, viz. the product obtained after partial hydrolysis of trimethyl aluminum plus another trialkyl aluminum such as tri(isobutyl) aluminum or tri-n-octyl aluminum.

Fluorinated aryl borates as used in the present description may mean: a borate compound having four fluorinated (preferably perfluorinated) aryl ligands.

### Optional Scavenger

A scavenger can optionally be added to the catalyst system in order to react with impurities that are present in the polymerization reactor, and/or in the solvent and/or monomer feed. This scavenger prevents poisoning of the catalyst during the olefin polymerization process. The optional scavenger is selected from the group: trimethyl aluminum, triethyl aluminum, triisobutyl aluminum, trihexyl aluminum, trioctyl aluminum, preferably triethyl aluminum.

Surprisingly, triethyl aluminum does not lead to severe chain transfer and does not inhibit the catalyst comprising the ligand-metal complex as describe above. This feature allows to use triethyl aluminum instead of triisobutyl aluminum, which is a great cost benefit.

### Optional Chain Transfer Agent

Optional chain transfer agent is selected from the group: dihydrogen or AlR¹⁰₃, BR¹⁰₃ or ZnR¹⁰₂, where each R¹⁰ is independently selected from hydrogen or hydrocarbyl.

### Polymerization Conditions

The polymerization according to the invention is performed in a solution process using a catalyst system as described above.

In the process the polymerization conditions like for example temperature, time, pressure, monomer concentration can be chosen within wide limits. The polymerization temperature is in the range from 100 to 250° C., preferably 110 to 210° C., more preferably 130 to 180° C. The polymerization time is in the range of from 10 seconds to 20 hours, preferably from 1 minute to 2 hours, preferably 2 minutes to 1 hour, more preferably 5 to 30 minutes. The molecular weight of the polymer can be controlled by use of hydrogen or other chain transfer agents. The polymerization may be conducted by a batch process, a semi-continuous process or a continuous process and may also be conducted in two or more steps of different polymerization conditions. The polyolefin produced is separated from the polymerization solvent and dried by methods known to a person skilled in the art.

In an embodiment, a hindered phenol, such as for example butylated hydroxytoluene (BHT), may be added during the polymerization process, especially for example in an amount between 0.1 and 5 mol. equivalents of main group metal compound(s), used as scavenger, co-catalyst and/or protecting agent. This may contribute to increase molecular weight and/or comonomer incorporation.

Preferably, the amount of the functionalized olefin monomers in step a) is from 0.01 to 20 mol %, preferably from 0.02 to 15 mol % or from 0.05 to 10 mol %, or from 0.1 to 5 mol %, more preferably 0.02 to 2 mol %, with respect to the total molar amount of the olefin monomers and the functionalized olefin monomers.

The invention may involve a further addition of other additives such as a processing stabilizer (primary antioxidant) such as Irganox 1010.

### Step b)

Following the polymerization step a), a deprotection step b) is performed where the product obtained by step a) is treated to abstract the residue derived from the protecting agent from the protected functionalized olefin copolymer to obtain the functionalized polyolefin.

In an embodiment, the protected functionalized olefin copolymer is treated with a Bronsted acid, preferably HCl.

In another embodiment, the protected functionalized olefin copolymer is treated with a base solution, preferably Bronsted base, more preferably NaOH.

In another embodiment, the protected functionalized olefin copolymer is treated with water.

In order to prevent the corrosion of the polymerization reactor, the deprotection step may be carried out in a tank coated with PE, PTFE or PFA, and the base material is stainless steel when a base is used or carbon steel when an acid is used.

Optionally, a deashing step may be performed after the deprotection step in order to separate the aluminum species such as aluminum oxides and hydroxides, for example Al(O)OH, Al(OH)₃ and Al₂O₃, insoluble in water from the polymer by flocculation and settling, filtration including membrane separation, centrifugal separation, or adsorption.

However, such deashing step may be skipped in particular when the functionalized polyolefin obtained by a process according to the invention is used in a foam article. In this embodiment, the aluminum species such as aluminum oxide hydroxide will help to create the foam.

Optionally, a neutralization step may be performed on the aqueous phase containing the aluminum species such as aluminum oxide hydroxide with a sodium hydroxide solution when an acid is used during the deprotection step, and with sulfuric acid solution or CO₂ gas when a base is used during the deprotection step.

It is noted that the invention relates to all possible combinations of features described herein, preferred in particular are those combinations of features that are present in the claims. It is in particular noted that the preferred materials or preferred amounts of materials as disclosed in the context of the process according to the invention equally apply to the functionalized olefin copolymer and/or the functionalized olefin copolymer composition.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following non-limiting examples.

### EXAMPLES

### ¹H NMR Characterization

The percentage of functionalization was determined by ¹H NMR analysis carried out at 130° C. using deuterated tetrachloroethane (TCE-D2) as solvent and recorded in 5 mm tubes on a Varian Mercury spectrometer operating at a frequency of 400 MHz. Chemical shifts are reported in ppm versus tetramethylsilane and were determined by reference to the residual solvent protons.

### High Temperature Size Exclusion Chromatography (HT-SEC)

The molecular weights, reported in kg·mol⁻¹, and the PDI were determined by means of high temperature size exclusion chromatography, which was performed at 150° C. in a GPC-IR instrument equipped with an IR4 detector and a carbonyl sensor (PolymerChar, Valencia, Spain). Column set: three Polymer Laboratories 13 μm PLgel Olexis, 300×7.5 mm. 1,2-Dichlorobenzene (o-DCB) was used as eluent at a flow rate of 1 mL·min⁻¹. The molecular weights and the corresponding PDIs were calculated from HT SEC analysis with respect to narrow polystyrene standards (PSS, Mainz, Germany).

### Differential Scanning Calorimetry (DSC)

Thermal analysis was carried out on a DSC Q100 from TA Instruments at a heating rate of 5° C.·min⁻¹. First and second runs were recorded after cooling down to ca. −40° C. All copolymers were found to be amorphous as determined by DSC.

### Inductively Coupled Plasma Mass Spectrometry Analysis (ICP-MS)

The aluminium content (wt. %) was determined using ICP-MS: 100-200 mg of sample is digested in 6 mL concentrated nitric acid (trace metal grade) by microwave assisted acid digestion using an Anton Paar Multiwave PRO equipped with closed high pressure Quartz digestion vessels. After the microwave digestion run, the acid is analytically transferred into a pre-cleaned plastic centrifuge tube containing 1 mL of internal standard solution and is diluted with Milli-Q water up to the 50 mL mark. The aluminum in the samples is quantified using multi-element calibration standards from Inorganic Ventures. The aluminum is detected and measured using an Agilent 8900 ICP-MS system by measuring the aluminum at the 27 m/z Isotope in (High Energy) Helium Collision mode.

### Example 1

The copolymerization experiments were carried out using a stainless steel BÜCHI reactor (2 L) filled with pentamethylheptane (PMH) solvent (1 L) using a stirring speed of 600 rpm. Catalyst and comonomer solutions were prepared in a glove box. For example, for entry 2, Table 1, the reactor was first heated to 40° C. followed by addition of TiBA (1.0 M solution in toluene, 2 mL) and TiBA-pacified 10-undecen-1-ol (TiBA:10-undecen-1-ol=1:0, 1.0 M solution in toluene, 20 mmol). The reactor was charged at 40° C. with gaseous propylene (100 g) and the reactor was heated up to the desired polymerization temperature of 130° C. resulting in a partial propylene pressure of about 15 bar. Once the set temperature was reached, the polymerization reaction was initiated by the injection of the pre-activated catalyst precursor bis((2-oxoyl-3-(dibenzo-1H-pyrrole-1-yl)-5-(methyl) phenyl)-2-phenoxy)-2,4-pentanediylhafnium (IV) dimethyl [CAS 958665-18-4]; other name hafnium [[2′,2′″-[(1,3-dimethyl-1,3-propanediyl)bis(oxy-κO)]bis[3-(9H-carbazol-9-yl)-5-methyl [1,1′-biphenyl]-2-olato-κO]](2-)]dimethyl] (Hf-O4,0.25 mg, 0.25 μmol) in MAO (30 wt % solution in toluene, 11.3 mmol). The reaction was stopped by pouring the polymer solution into an Erlenmeyer flask containing acidified isopropanol (2.5% v/v HCl, 500 mL) and Irganox 1010 (1.0 M, 0.5 mmol). The resulting suspension was stirred for 4 h, filtered, washed with demineralized water/iPrOH (50 wt %, 2×500 mL) and dried at 80° C. in a vacuum oven, prior the addition of Irganox 1010 as antioxidant. The poly(propylene-co-1-undecenol) (20.9 g) was obtained as a white powder.

TABLE 1a
Copolymerization of propylene with TiBA or TEA protected 10-undecenol,
5-hexen-1-ol and 3-buten-1-ol using Hf—O4 catalyst.

| | T | | Co-monomer | Time | Yield | Mₙ | M_{w} | | Tₘ | Co-momoner | Al content |
|---|---|---|---|---|---|---|---|---|---|---|---|
| Ref | (° C.) | Co-monomer | (mM) | (min.) | (g) | (kg/mol) | (kg/mol) | PDI | (° C.) | (mol %) | (wt %) |
| 1 | 130 | n.a. | n.a. | 18 | 64.3 | 47.7 | 252.8 | 5.3 | 151.1 | n.a. | n.d. |
| 2 | | C11OH/TiBA | 20 | 30 | 20.9 | 53.7 | 236.3 | 4.4 | 136.2 | 1.06 | 0.76 |
| 3 | | C11OH/TiBA | 20 | 9 | 28.4 | 67.6 | 263.6 | 3.9 | 140.5 | 0.76 | n.d. |
| 4 | | C4OH/TiBA | 30 | 10 | 43.5 | 67.9 | 210.5 | 3.1 | 147.5 | 0.3 | n.d. |
| 5 | | C4OH/TEA | 10 | 10 | 13.2 | 84.9 | 297.1 | 3.5 | 149.1 | 0.1 | n.d. |
| 6 | | C6OH/TiBA | 20 | 14 | 20.3 | 54.1 | 254.3 | 4.7 | 143.4 | 0.38 | n.d. |
| 7 | | C6OH/TEA | 10 | 10 | 19.6 | 44.1 | 127.9 | 2.9 | 144.9 | 0.34 | 0.96 |
| 8 | | C6OH/TEA | 20 | 10 | 10.5 | 52.3 | 172.6 | 3.3 | 139.9 | 0.67 | n.d. |
| 9 | | C6OH/TEA | 30 | 10 | 9.0 | n.s. | n.s. | n.s. | 135.0 | 1.0 | n.d. |
| 10 | | C10COOH/TiBA | 7.5 | 10 | 37.3 | 63.2 | 183.3 | 2.9 | 145.4 | n.d. | n.d. |
| 11 | | C10COOH/TiBA | 10 | 20 | 4.7 | n.s. | n.s. | n.s. | 147.3 | n.d. | n.d. |
| 12 | 150 | n.a. | n.a. | 14 | 13.5 | 42.3 | 211.5 | 5.0 | 147.6 | n.a. | n.d. |
| 13 | | C11O/TiBA | 20 | 18 | 15.5 | 30.5 | 140.3 | 4.6 | 138.0 | 0.37 | 0.62 |
| 14 | | C11OH/TiBA | 25 | 14 | 23.4 | 37.6 | 112.8 | 3.0 | 136.3 | 0.98 | n.d. |
| 15 | | C4OH/TiBA | 10 | 10 | 25.0 | 23.9 | 76.5 | 3.2 | 145.3 | 0.10 | n.d. |
| 16 | | C4OH/TEA | 10 | 10 | 21.2 | 24.3 | 77.8 | 3.2 | 149.1 | 0.08 | n.d. |
| 17 | | C6OH/TiBA | 20 | 14 | 18.5 | 27.5 | 107.3 | 3.9 | 141.8 | 0.47 | n.d. |
| 18 | | C6OH/TEA | 20 | 10 | 12.3 | 25.8 | 80.0 | 3.1 | 145.1 | 0.17 | n.d. |

### Conditions:

Reactions performed in a 2 L BÜCHI reactor using bis((2-oxoyl-3-(dibenzo-1H-pyrrole-1-yl)-5-(methyl) phenyl)-2-phenoxy)-2,4-pentanediylhafnium (IV) dimethyl (HfO4=0.24 μmol) [CAS 958665-18-4]; other name hafnium, [[2′,2′″-[(1,3-dimethyl-1,3-propanediyl)bis(oxy-κO)]bis[3-(9H-carbazol-9-yl)-5-methyl[1,1′-biphenyl]-2-olato-κO]](2-)]dimethyl] (Hf-O4), propylene partial pressure=15 bar at polymerization temperature, pentamethylheptane=1 L, MAO (30 wt % solution in toluene)=11.3 mmol, TiBA or TEA pacified alkenol (C11OH is 10-undecen-1-ol, C6OH is 5-hexen-1-ol, C4OH is 3-buten-1-ol); TiBA or TEA:alkenol (mol ratio)=1, additional amount of TiBA (1.0 M solution in toluene, 2 mL) was added as scavenger.

TiBA:10-undecenoic acid (mol ratio)=2.

The yield determined using the weight of polymer obtained after filtration and drying in vacuum oven overnight at 80° C.

n.a.=not applicable, n.s.=not soluble, n.d.=not determined.

TABLE 1b
Copolymerization of propylene with TEA protected 10-undecenol, 5-hexen-1-ol using Zr—O4 catalyst.

| | T | | Co-monomer | Time | Yield | Mₙ | M_{w} | | Tₘ | Co-monomer |
|---|---|---|---|---|---|---|---|---|---|---|
| Ref | (° C.) | Co-monomer | (mM) | (min.) | (g) | (kg/mol) | (kg/mol) | PDI | (° C.) | (mol %) |
| 19 | 130 | C6OH/TEA | 5 | 10 | 2.2 | 52.3 | 115.3 | 2.2 | 119 | 0.28 |
| 20 | | C11OH/TEA | 5 | 10 | 1.8 | 39.0 | 72.6 | 1.9 | 114 | 0.33 |

### Conditions:

Reactions performed in 0.3 L BÜCHI reactors using bis((2-oxoyl-3-(dibenzo-1H-pyrrole-1-yl)-5-(methyl) phenyl)-2-phenoxy)-2,4-pentanediylzirconium (IV) dimethyl (Zr-O4, 0.1 μmol) [CAS: 1407984-39-7]; other name: zirconium [[2′,2′″-[(1,3-dimethyl-1,3-propanediyl)bis(oxy-κO)]bis[3-(9H-carbazol-9-yl)-5-methyl[1,1′-biphenyl]-2-olato-κO]](2-)]dimethyl], propylene partial pressure=15 bar, pentamethylheptane=0.15 L, MAO (30 wt % solution in toluene)=4.5 mmol, TEA pacified alkenol (C11OH is 10-undecen-1-ol, C6OH is 5-hexen-1-ol); TEA:alkenol (mol ratio)=1; additional amount of TiBA (1.0 M solution in toluene, 1 mL) was added as scavenger. The yield determined using the weight of polymer obtained after filtration and drying in vacuum oven overnight at 80° C.

### Results of Tables 1a and 1b.

The results presented in Tables 1a and 1b show that copolymers based on propylene and a protected alkenol produced by the process according to the invention have significantly higher M_{w}, Mₙ and Tₘ with a hafnium or zirconium complex of a polyvalent aryloxyether as catalyst than when a metallocene is used as catalyst under the same conditions (see comparative examples described in Tables 4a, 4b and 5).

### Example 2

The same polymerization procedure as described in example 1 was applied to produce poly(propylene-co-1-hexene-co-5-hexen-1-ol) (entry 21, Table 2) using bis((2-oxoyl-3-(dibenzo-1H-pyrrole-1-yl)-5-(methyl)phenyl)-2-phenoxy)-2,4-pentanediylhafnium (IV) dimethyl (Hf-O4) catalyst (0.75 μmol), 1-hexene (5 mL, 40 mmol), which was injected along with TiBA scavenger (1.0 M solution in toluene, 2 mL) and TEA-pacified 5-hexene-1-ol comonomer solution (TEA:5-hexene-1-ol (mol ratio)=1; 10 mM). The resulting hydroxyl functionalized poly(propylene-co-1-hexene-co-1-hexen-1-ol) (11.7 g) was analyzed by HT-SEC to determine the molecular weight, DSC to determine the melting temperature and ¹H NMR to determine the functionality level.

TABLE 2
Copolymerization of propylene with 1-hexene and TEA protected 5-hexen-1-ol using Hf—O4 catalyst.

| | T | | Co-monomer | 1-hexene | Time | Yield | Mₙ | M_{w} | | Tₘ | Co-monomer |
|---|---|---|---|---|---|---|---|---|---|---|---|
| Ref | (° C.) | Co-Monomer | (mM) | (mM) | (min.) | (g) | (kg/mol) | (kg/mol) | PDI | (° C.) | (mol %) |
| 21 | 130 | C6OH/TEA | 10 | 40 | 10 | 11.7 | 44.5 | 129.0 | 2.9 | 134.2 | 0.32 |
| 22 | | | 10 | 80 | 10 | 11.2 | 52.9 | 158.7 | 3.0 | 127.6 | 0.34 |
| 23 | | | 10 | 120 | 10 | 8.2 | 42.2 | 130.8 | 3.1 | 109.4 | 0.41 |

### Conditions:

Reactions performed in a 2 L BÜCHI reactor using Hf-O4=0.72 μmol, propylene partial pressure=15 bar, pentamethylheptane=1 L, MAO (30 wt % solution in toluene)=11.3 mmol, TEA-pacified 5-hexene-1-ol comonomer solution TEA: 5-hexene-1-ol (mol ratio)=1, additional amount of TiBA (1.0 M solution in toluene, 2 mL) was added as scavenger.

The yield determined using the weight of polymer obtained after filtration and drying in vacuum oven overnight at 60° C.

### Results of Table 2.

The results presented in Table 2 show that terpolymers based on propylene, 1-hexene and a protected alkenol produced by the process according the invention using a hafnium complex of a polyvalent aryloxyether as catalyst show similar high M_{w}, Mₙ and Tₘ as found for the copolymers (Table 1a).

In addition Table 2 shows high ability of Hf-O4 to form high M_{w} terpolymers with high Tₘ, whereas the Tₘ can be tuned by adjusting the amount of 1-hexene in the feed.

### Example 3

Terpolymerization experiments of ethylene, 1-octene with 5-hexen-1-ol or 3-buten-1-ol using the Hf-O4 catalyst were carried out in the Parallel Pressure Reactor platform (PPR) setup integrally embedded in a triple MBraun LabMaster glove-box and features 48 reactors (“cells”) arrayed in six modules of 8-cell each. The cells, each with a working volume of 5.0 mL for the liquid phase are controlled individually with on-line monitoring of temperature, pressure. Prior to the execution of the experiments, the PPR modules undergo conditioning overnight cycles (8 h at 90-140° C. with intermittent dry N₂ flow). After cooling to the glove-box temperature, the 48 cells were fitted with disposable 10 mL glass inserts and disposable polyether ether ketone (PEEK) stirring paddles. For example, for entry 28 of Table 3, the modules were loaded with toluene (5.0 mL), MAO used as scavenger (30 wt % solution in toluene, 13 μmol), 1-octene (0.25 mL, 5 vol %) and TiBA-pacified 5-hexene-1-ol comonomer solution (TiBA:5-hexene-1-ol=1:1, 0.2 μmol). The module was thermostated at the desired temperature (130° C.) and brought to the predefined operating ethylene pressure (9 bar). At this point, Hf-O4 catalyst (2.0 nmol) pre-activated with MAO (30 wt % solution in toluene, 2 μmol, MAO/cat.=1000) was injected into the destination cell, thus starting the reaction. The total liquid phase volume of 5.0 mL was partitioned as: 4.0 mL was loaded during the solvent/scavenger addition and 1.0 mL during the catalyst injection sequence. The polymerization was left to proceed under stirring (800 rpm) at constant ethylene pressure for the desired polymerization time, and quenched by over-pressurizing the cell with 3.5 bar of a O₂/N₂ mixture (O₂, 0.5 v %). Once the cell was quenched, the module was cooled down to the glove box temperature and vented, the stir-top was removed, and the glass insert containing the reaction phase was taken out and transferred to a Genevac centrifugal drying station, where the polymer sample was thoroughly dried under vacuum overnight.

TABLE 3
Terpolymerization of ethylene, 1-octene with TiBA protected
5-hexen-1-ol or TiBA 3-buten-1-ol using Hf—O4 catalyst.

| | T | | 1-octene | Rp (g/(μmol | Mₙ | M_{w} | | Tₘ |
|---|---|---|---|---|---|---|---|---|
| Ref. | (° C.) | Co-monomer | (vol %) | cat · [C₂⁼] · h) | (kg/mol) | (kg/mol) | PDI | (° C.) |
| 24 | 110 | C4OH/TiBA | 5 | 1138 | 216.2 | 605.4 | 2.8 | amorphous |
| 25 | | | 5 | 2864 | 262.3 | 577.0 | 2.2 | amorphous |
| 26 | | C6OH/TiBA | 5 | 1564 | 224.4 | 605.9 | 2.7 | amorphous |
| 27 | | | 5 | 2382 | 242.9 | 558.7 | 2.3 | amorphous |
| 28 | 130 | C4OH/TiBA | 5 | 391 | 156.4 | 406.6 | 2.6 | amorphous |
| 27 | | | 5 | 377 | 210.6 | 526.5 | 2.5 | amorphous |
| 28 | | C6OH/TiBA | 5 | 658 | 203.3 | 508.2 | 2.5 | amorphous |
| 29 | | | 5 | 341 | 161.2 | 435.2 | 2.7 | amorphous |

### Conditions:

Reactions performed in the Parallel Pressure Reactor platform (PPR) using Hf-O4=2 nmol, ethylene pressure=9 bar, time=10 minutes, total toluene volume including reagents=5 mL, MAO (30 wt % solution in toluene)=15 μmol, TiBA pacified alkenols (C6OH is 5-hexen-1-ol and C4OH is 3-buten-1-ol); TiBA:alkenol (mol ratio)=1. For more experimental details see experimental procedure example 3.

### Results of Table 3.

The results presented in Table 3 show that the terpolymers based on ethylene, 1-octene and TiBA-protected alkenols produced by the process according the invention using a hafnium complex of a polyvalent aryloxyether as catalyst show high M_{w} and Mₙ. However, due to high affinity of Hf-O4 to alkenols and 1-octene, the ethylene-based terpolymers obtained under the applied polymerization conditions are amorphous and no Tₘ has been obtained.

### Comparatives Examples

The following comparatives examples are performed with no hafnium or zirconium complex of a polyvalent aryloxyether catalysts according to the invention:
rac-Me₂Si(2-Me-4-Ph-Ind)₂ZrCl₂ catalyst.
rac-Me₂Si(2-Me-4-Ph-Ind)₂HfCl₂ catalyst.
TiCl₄/MgCl₂Ziegler-Natta catalyst.

TABLE 4a
Copolymerization of propylene with TiBA protected 10-undecen-1-ol and TiBA
protected 3-buten-1-ol using rac-Me₂Si(2-Me-4-Ph-Ind)₂ZrCl₂ catalyst.

| | T | | Co-monomer | Time | Yield | Mₙ | M_{w} | | Tₘ | Co-momoner |
|---|---|---|---|---|---|---|---|---|---|---|
| Ref | (° C.) | Co-monomer | (vol %) | (min.) | (mg) | (kg/mol) | (kg/mol) | PDI | (° C.) | (mol %) |
| CE1 | 150 | — | — | 10 | 48 | 2.3 | 4.7 | 2.0 | 113.0 | 0 |
| CE2 | | C11O/TiBA | 20 | 10 | 38 | 1.3 | 2.1 | 1.7 | 41.0 | 0.3 |
| CE3 | | C4O/TiBA | 2.5 | 10 | 29 | 1.9 | 3.9 | 2.0 | no | 0.1 |
| | | | | | | | | | peak | |

### Conditions:

Reactions performed in the Parallel Pressure Reactor platform (PPR) using rac-Me₂Si(2-Me-4-Ph-Ind)₂ZrCl₂ catalyst=20 nmol, propylene pressure=6 bar, toluene=5 mL, MAO (30 wt % solution in toluene)=15 μmol, TiBA pacified alkenol (C11OH is 10-undecen-1-ol, C4OH is 3-buten-1-ol); TiBA:alkenol (mol ratio)=1.

CE1 is the reference propylene polymerization with rac-Me₂Si(2-Me-4-Ph-Ind)₂ZrCl₂ catalyst.

TABLE 4b
Copolymerization of propylene with TEA- and TiBA protected
5-hexen-1-ol using rac-Me₂Si(2-Me-4-Ph-Ind)₂ZrCl₂ catalyst.

| | T | | Co-monomer | Time | Yield | Mₙ | M_{w} | | Tₘ | Co-momoner |
|---|---|---|---|---|---|---|---|---|---|---|
| Ref | (° C.) | Co-Monomer | (mM) | (min.) | (g) | (kg/mol) | (kg/mol) | PDI | (° C.) | (mol %) |
| CE4 | 130 | — | — | 10 | 33.5 | 6.2 | 16.2 | 2.6 | 129.2 | 0 |
| CE5 | | C6OH/TiBA | 20 | 10 | 9.8 | 8.3 | 27.4 | 3.3 | 116.3 | 0.44 |
| CE6 | | C6O/TEA | 20 | 10 | 7.8 | 6.1 | 18.9 | 3.1 | 110.2 | 0.52 |
| CE7 | 150 | C6O/TEA | 20 | 10 | 2.2 | 3.1 | 17.7 | 5.7 | 106.3 | n.d. |

### Conditions:

Reactions performed in a 2 L BUCHI reactor using rac-Me₂Si(2-Me-4-Ph-Ind)₂ZrCl₂=3.2 μmol, propylene partial pressure=15 bar pentamethylheptane=1.0 L, MAO (30 wt % solution in toluene)=11.3 mmol, TiBA or TEA pacified C6OH (5-hexen-1-ol); TiBA or TEA:5-hexen-1-ol (mol ratio)=1, additional amount of TiBA (1.0 M solution in toluene, 2 mL) was added as scavenger. The yield determined using the weight of polymer obtained after filtration and drying in vacuum oven overnight at 80° C.

CE4 is the reference propylene polymerization with rac-Me₂Si(2-Me-4-Ph-Ind)₂ZrCl₂ catalyst.

n.d.=not determined.

TABLE 5
Copolymerization of propylene with TiBA protected 10-undecen-
1-ol using rac-Me₂Si(2-Me-4-Ph-Ind)₂HfCl₂ catalyst.

| | T | | Co-monomer | Time | Yield | Mₙ | M_{w} | | Tₘ | Co-monomer |
|---|---|---|---|---|---|---|---|---|---|---|
| Ref | (° C.) | Co-monomer | (mM) | (min.) | (g) | (kg/mol) | (kg/mol) | PDI | (° C.) | (mol %) |
| CE8 | 100 | n.a. | n.a. | 20 | 21.7 | 12.1 | 27.8 | 2.3 | 130.1 | 0 |
| CE9 | | C11OH/TiBA | 10 | 20 | 16.0 | 14.3 | 24.3 | 2.4 | 129.4 | 0.1 |
| CE10 | | C11OH/TiBA | 20 | 20 | 13.3 | 14.8 | 34.0 | 2.3 | 129.0 | 0.1 |

### Conditions:

Reactions performed in a 0.6 L BÜCHI reactor using rac-Me₂Si(2-Me-4-Ph-Ind)₂HfCl₂ catalyst=0.3 μmol, propylene partial pressure=15 bar,, toluene=200 mL, MAO (30 wt % solution in toluene)=1 mmol, TiBA pacified 10-undecen-1-ol (C11OH) mol ratio=1, additional amount of TiBA (1.0 M solution in toluene, 1 mL) was added as scavenger.

The yield determined using the weight of polymer obtained after filtration and drying in vacuum oven overnight at 80° C.

CE8 is the reference propylene polymerization with rac-Me₂Si(2-Me-4-Ph-Ind)₂HfCl₂ catalyst.

The results presented in Tables 4a 4b and 5 show that the polymers produced have very low M_{w} and Mₙ and Tₘ values under the solution process conditions according to the invention (Table 1a) but using other zirconium and hafnium complexes falling outside of the definition above: zirconium and hafnium complexes of a polyvalent aryloxyether. In addition there is almost no functionalization.

TABLE 6
Copolymerization of propylene, TiBA protected 10-undecen-1-ol using Ziegler-
Natta catalyst: TiCl₄/MgCl₂/di-n-butylphtalate-TEA/diisobutyldimethoxysilane.

| | T | | | H₂ | Time | Yield | Mₙ | M_{w} | | Tₘ | Co-monomer |
|---|---|---|---|---|---|---|---|---|---|---|---|
| Ref | (° C.) | Co-monomer | Co-monomer | (bar) | (min.) | (g) | (kg/mol) | (kg/mol) | PDI | (° C.) | (mol %) |
| CE11 | 130 | C11OH/TiBA | 15 | n.a. | 20 | 19.4 | 132.3 | 555.6 | 4.5 | 162.4 | 0 |
| CE12 | 130 | C11OH/TiBA | 15 | 0.5 | 20 | 30.8 | 69.8 | 314.1 | 4.2 | 161.7 | 0 |

Conditions: Reactions performed in a 2 L BÜCHI reactor using TiCl₄/MgCl₂ Z—N-catalyst=10 mg, propylene partial pressure=15 bar, pentamethylheptane=1 L, 1.2 mL diisobutyldimethoxysilane (DiBMS)=0.3 mmol, TEA (1.0 M solution in toluene)=1.5 mmol. TiBA pacified 10-undecen-1-ol comonomer solution (mol ratio=1), additional amount of TiBA (1.0 M solution in toluene, 2 mL) was added as scavenger.

The yield determined using the weight of polymer obtained after filtration and drying in vacuum oven overnight at 60° C.

The results presented in Table 6 show that with the TiCl₄/MgCl₂ Ziegler-Natta catalyst under solution process conditions according to the invention there is no functionalization as is revealed by ¹H NMR analysis.

1. A process for solution copolymerization to obtain a functionalized polyolefin comprising at least the following steps:
a) a copolymerization step of at least one olefin monomer and at least one protected functionalized olefin monomer in the presence of a catalyst system, wherein the olefin monomer is represented by CHR¹═CHR², wherein R¹ and R² are each independently hydrogen or a hydrocarbyl group having 1 to 6 carbon atoms, wherein the protected functionalized olefin monomer is a reaction product of a functionalized olefin monomer and a protecting agent during a protection step, wherein the functionalized olefin monomer is represented by the structure according to Formula (I): 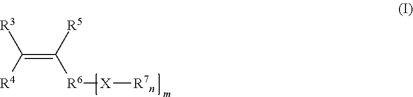
wherein R³, R⁴, and R⁵ are each independently H or a hydrocarbyl with 1 to 16 carbon atoms,
wherein R⁶—[X—(R⁷)ₙ]ₘ is a polar functional group containing m heteroatom-containing functionalities X—(R⁷)ₙ, in which m is an entire number between 1 and 10, X is —O—, —S—, —CO₂—, or —N— and n is an entire number between 1 and 2
wherein
when n is 1, X is —O—, —S— or —CO₂— and R⁷ is H, or
when n is 2, X is —N— and at least one R⁷ is H and the other R⁷ is H or a hydrocarbyl group with 1 to 16 carbon atoms,
wherein R⁶ is either —C(R⁸)(R⁹)— or a plurality of —C(R⁸)(R⁹)— groups, wherein R⁸ and R⁹ are each independently H or a hydrocarbyl with 1 to 16 carbon atoms and R⁶ comprises 1 to 10 carbon atoms,
wherein X is attached to either the main chain and/or side chain of R⁶,
wherein R⁴ and R⁶ may together form a ring structure that is functionalized with one or multiple X—(R⁷)ₙ,
and wherein the catalyst system comprises:
a hafnium complex of a polyvalent aryloxyether selected from the group consisting of: bis((2-oxoyl-3-(1,2,3,4,6,7,8,9-octahydroanthracen-5-yl)-5-(methyl) phenyl)-2-phenoxy)-1,3-propanediylhafnium (IV) dimethyl, bis((2-oxoyl-3-(1,2,3,4,6,7,8,9-octahydroanthracen-5-yl)-5-(methyl) phenyl)-2-phenoxy)-1,3-propanediylhafnium (IV) dichloride, bis((2-oxoyl-3-(1,2,3,4,6,7,8,9-octahydroanthracen-5-yl)-5-(methyl) phenyl)-2-phenoxy)-1,3-propanediylhafnium (IV) dibenzyl, bis((2-oxoyl-3-(dibenzo-1H-pyrrole-1-yl)-5-(methyl)phenyl)-2-phenoxy)-1,3-propanediylhafnium (IV) dimethyl, bis((2-oxoyl-3-(dibenzo-1H-pyrrole-1-yl)-5-(methyl)phenyl)-2-phenoxy)-1,3-propanediylhafnium (IV) dichloride, bis((2-oxoyl-3-(dibenzo-1H-pyrrole-1-yl)-5-(methyl)phenyl)-2-phenoxy)-1,3-propanediylhafnium (IV) dibenzyl, bis((2-oxoyl-3-(1,2,3,4,6,7,8,9-octahydroanthracen-5-yl)-5-(methyl)phenyl)-2-phenoxymethyl)-1,4-butanediylhafnium (IV) dimethyl, bis((2-oxoyl-3-(1,2,3,4,6,7,8,9-octahydroanthracen-5-yl)-5-(methyl)phenyl)-2-phenoxymethyl)-1,4-butanediylhafnium (IV) dichloride, bis((2-oxoyl-3-(1,2,3,4,6,7,8,9-octahydroanthracen-5-yl)-5-(methyl)phenyl)-2-phenoxymethyl)-1,4-butanediylhafnium (IV) dibenzyl, bis((2-oxoyl-3-(dibenzo-1H-pyrrole-1-yl)-5-(methyl)phenyl)-2-phenoxymethyl)-1,4-butanediylhafnium (IV) dimethyl, bis((2-oxoyl-3-(dibenzo-1H-pyrrole-1-yl)-5-(methyl)phenyl)-2-phenoxymethyl)-1,4-butanediylhafnium (IV) dichloride, bis((2-oxoyl-3-(dibenzo-1H-pyrrole-1-yl)-5-(methyl)phenyl)-2-phenoxymethyl)-1,4-butanediylhafnium (IV) dibenzyl, bis((2-oxoyl-3-(1,2,3,4,6,7,8,9-octahydroanthracen-5-yl)-5-(methyl)phenyl)-2-phenoxy)-2,4-pentanediylhafnium (IV) dimethyl, bis((2-oxoyl-3-(1,2,3,4,6,7,8,9-octahydroanthracen-5-yl)-5-(methyl)phenyl)-2-phenoxy)-2,4-pentanediylhafnium (IV) dichloride, bis((2-oxoyl-3-(1,2,3,4,6,7,8,9-octahydroanthracen-5-yl)-5-(methyl)phenyl)-2-phenoxy)-2,4-pentanediylhafnium (IV) dibenzyl, bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-(dibenzo-1H-pyrrole-1-yl)-5-(methyl)phenyl)-2-phenoxy)-2,4-pentanediyl hafnium (IV) dichloride, bis((2-oxoyl-3-(dibenzo-1H-pyrrole-1-yl)-5-(methyl)phenyl)-2-phenoxy)-2,4-pentanediylhafnium (IV) dibenzyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dimethyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dichloride, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dibenzyl, bis((2-oxoyl-3-(dibenzo-1H-pyrrole-1-yl)-5-(methyl)phenyl)-2-phenoxymethyl)-methylenetrans-1,2-cyclohexanediylhafnium (IV) dimethyl, bis((2-oxoyl-3-(dibenzo-1H-pyrrole-1-yl)-5-(methyl)phenyl)-2-phenoxymethyl)-methylenetrans-1,2-cyclohexanediylhafnium (IV) dichloride, and bis((2-oxoyl-3-(dibenzo-1H-pyrrole-1-yl)-5-(methyl)phenyl)-2-phenoxymethyl)-methylenetrans-1,2-cyclohexanediylhafnium (IV) dibenzyl, bis((2-oxoyl-3-(dibenzo-1H-pyrrole-1-yl)phenyl)-2-phenoxy)-1,3-propylhafnium (IV) dibenzyl, bis((2-oxoyl-3-(dibenzo-1H-pyrrole-1-yl)phenyl)-2-phenoxy)-1,4-n-butylhafnium (IV) dimethyl, bis((2-oxoyl-3-(dibenzo-1H-pyrrole-1-yl)phenyl)-2-phenoxy)-1,4-n-butylhafnium (IV) dibenzyl, bis((2-oxoyl-3-(3,6-bis(1,1-dimethylethyl)-9H-carbazolyl)phenyl)-2-phenoxy)-1,3-propylhafnium (IV) dimethyl, bis((2-oxoyl-3-(3,6-bis(1,1-dimethylethyl)-9H-carbazolyl)phenyl)-2-phenoxy)-1,3-propylhafnium (IV) dibenzyl, bis((2-oxoyl-3-(3,6-bis(1,1-dimethylethyl)-9H-carbazolyl)phenyl)-2-phenoxy)-1,4-n-butylhafnium (IV) dimethyl, bis((2-oxoyl-3-(3,6-bis(1,1-dimethyl ethyl)-9H-carbazolyl)phenyl)-2-phenoxy)-1,4-n-butylhafnium (IV) dibenzyl, bis((2-oxoyl-3-(4-methoxy-3,5-bis(1,1-dimethylethyl) phenyl)phenyl)-2-phenoxy)-1,4-n-butylhafnium (IV) dimethyl, bis((2-oxoyl-3-(4-methoxy-3,5-bis(1,1-dimethylethyl)phenyl) phenyl)-2-phenoxy)-1,4-n-butylhafnium (IV) dibenzyl, bis((2-oxoyl-3-(dibenzo-1H-pyrrole-1-yl) phenyl)-2-phenoxy)-1,2-ethylhafnium (IV) dimethyl, bis((2-oxoyl-3-(dibenzo-1H-pyrrole-1-yl)phenyl)-2-phenoxy)-1,2-ethylhafnium (IV) dibenzyl, and bis((2-oxoyl-3-(dibenzo-1H-pyrrole-1-yl)phenyl)-2-phenoxy)-1,3-propylhafnium (IV) dimethyl;
a zirconium complex of a polyvalent aryloxyether selected from the group consisting of: bis((2-oxoyl-3-(dibenzo-1H-pyrrole-1-yl)-5-(methyl)phenyl)-2-phenoxy)-2,4-pentanediylzirconium (IV) dimethyl, bis((2-oxoyl-3-(dibenzo-1H-pyrrole-1-yl)-5-(methyl)phenyl)-2-phenoxy)-2,4-pentanediylzirconium (IV) dichloride, bis((2-oxoyl-3-(1,2,3,4,6,7,8,9-octahydroanthracen-5-yl)-5-(methyl)phenyl)-2-phenoxy)-1,3-propanediylzirconium (IV) dimethyl, bis((2-oxoyl-3-(1,2,3,4,6,7,8,9-octahydroanthracen-5-yl)-5-(methyl)phenyl)-2-phenoxy)-1,3-propanediylzirconium (IV) dichloride, bis((2-oxoyl-3-(1,2,3,4,6,7,8,9-octahydroanthracen-5-yl)-5-(methyl)phenyl)-2-phenoxy)-1,3-propanediylzirconium (IV) dibenzyl, bis((2-oxoyl-3-(dibenzo-1H-pyrrole-1-yl)-5-(methyl)phenyl)-2-phenoxy)-1,3-propanediylzirconium (IV) dimethyl, bis((2-oxoyl-3-(dibenzo-1H-pyrrole-1-yl)-5-(methyl)phenyl)-2-phenoxy)-1,3-propanediylzirconium (IV) dichloride, bis((2-oxoyl-3-(dibenzo-1H-pyrrole-1-yl)-5- (methyl)phenyl)-2-phenoxy)-1,3-propanediylzirconium (IV) dibenzyl, bis((2-oxoyl-3-(1,2,3,4,6,7,8,9-octahydroanthracen-5-yl)-5-(methyl)phenyl)-2-phenoxymethyl)-1,4-butanediylzirconium (IV) dimethyl, bis((2-oxoyl-3-(1,2,3,4,6,7,8,9-octahydroanthracen-5-yl)-5-(methyl)phenyl)-2-phenoxymethyl)-1,4-butanediylzirconium (IV) dichloride, bis((2-oxoyl-3-(1,2,3,4,6,7,8,9-octahydroanthracen-5-yl)-5-(methyl)phenyl)-2-phenoxymethyl)-1,4-butanediylzirconium (IV) dibenzyl, bis((2-oxoyl-3-(dibenzo-1H-pyrrole-1-yl)-5-(methyl)phenyl)-2-phenoxymethyl)-1,4-butanediylzirconium (IV) dimethyl, bis((2-oxoyl-3-(dibenzo-1H-pyrrole-1- yl)-5-(methyl)phenyl)-2-phenoxymethyl)-1,4-butanediylzirconium (IV) dichloride, bis((2-oxoyl-3-(dibenzo-1H-pyrrole-1-yl)-5-(methyl)phenyl)-2-phenoxymethyl)-1,4-butanediylzirconium (IV) dibenzyl, bis((2-oxoyl-3-(1,2,3,4,6,7,8,9-octahydroanthracen-5-yl)-5-(methyl)phenyl)-2-phenoxy)-2,4-pentanediylzirconium (IV) dimethyl, bis((2-oxoyl-3-(1,2,3,4,6,7,8,9-octahydroanthracen-5-yl)-5-(methyl)phenyl)-2-phenoxy)-2,4-pentanediylzirconium (IV) dichloride, bis((2-oxoyl-3-(1,2,3,4,6,7,8,9-octahydroanthracen-5-yl)-5-(methyl)phenyl)-2-phenoxy)-2,4-pentanediylzirconium (IV) dibenzyl, bis((2-oxoyl-3-(dibenzo-1H-pyrrole-1-yl)-5-(methyl)phenyl)-2-phenoxy)-2,4-pentanediylzirconium (IV) dibenzyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dimethyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dichloride, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dibenzyl, bis((2-oxoyl-3-(dibenzo-1H-pyrrole-1-yl)-5-(methyl)phenyl)-2-phenoxymethyl)-methylenetrans-1,2-cyclohexanediylzirconium (IV) dimethyl, bis((2-oxoyl-3-(dibenzo-1H-pyrrole-1-yl)-5-(methyl)phenyl)-2-phenoxymethyl)-methylenetrans-1,2-cyclohexanediylzirconium (IV) dichloride, and bis((2-oxoyl-3-(dibenzo-1H-pyrrole-1-yl)-5-(methyl)phenyl)-2-phenoxymethyl)-methylenetrans-1,2-cyclohexanediylzirconium (IV) dibenzyl, bis((2-oxoyl-3-(4-methoxy -3,5-bis(1,1-dimethylethyl)phenyl)phenyl)-2-phenoxy)-1,4-n-butylzirconium (IV) dimethyl, bis((2-oxoyl-3-(4-methoxy-3,5-bis(1,1-dimethylethyl)phenyl)phenyl)-2-phenoxy)-1,4-n-butylzirconium (IV) dibenzyl, bis((2-oxoyl-3-(dibenzo-1H-pyrrole-1-yl)phenyl)-2-phenoxy)-1,2-ethylzirconium (IV) dimethyl, bis((2-oxoyl-3-(dibenzo-1H-pyrrole-1-yl)phenyl)-2-phenoxy)-1,2-ethylzirconium (IV) dibenzyl, bis((2-oxoyl-3-(dibenzo-1H-pyrrole-1-yl)phenyl)-2-phenoxy)-1,3-propyl zirconium (IV) dimethyl, bis((2-oxoyl-3-(dibenzo-1H-pyrrole-1-yl)phenyl)-2-phenoxy)-1,3-propylzirconium (IV) dibenzyl, bis((2-oxoyl-3-(dibenzo-1H-pyrrole-1-yl)phenyl)-2-phenoxy)-1,4-n-butylzirconium (IV) dimethyl, bis((2-oxoyl-3-(dibenzo-1H-pyrrole-1-yl)phenyl)-2-phenoxy)-1,4-n-butylzirconium (IV) dibenzyl, bis((2-oxoyl-3-(3,6-bis(1,1-dimethylethyl)-9H-carbazolyl)phenyl)-2-phenoxy)-1,3-propylzirconium (IV) dimethyl, bis((2-oxoyl-3-(3,6-bis(1,1-dimethylethyl)-9H-carbazolyl)phenyl)-2-phenoxy)-1,3-propylzirconium (IV) dibenzyl, bis((2-oxoyl-3-(3,6-bis(1,1-dimethylethyl)-9H-carbazolyl)phenyl)-2-phenoxy)-1,4-n-butylzirconium (IV) dimethyl, and bis((2-oxoyl-3-(3,6-bis(1,1-dimethylethyl)-9H-carbazolyl)phenyl)-2-phenoxy)-1,4-n-butylzirconium (IV) dibenzyl; and
a co-catalyst selected from the group: MAO, DMAO, MMAO, SMAO or ammonium salts or trityl salts of fluorinated tetraarylborates, and
optionally, a scavenger selected from the group: trimethyl aluminum, triethyl aluminum, triisobutyl aluminum, trihexyl aluminum, trioctyl aluminum and
optionally, a chain transfer agent selected from the group: dihydrogen or AlR¹⁰₃, BR¹⁰₃ or ZnR¹⁰₂, where each R¹⁰ is independently hydrogen or a hydrocarbyl.
b) a deprotection step where the product obtained by step a) is treated with water or a Brønsted acid or base solution, capable to abstract the residue derived from the protecting agent from the protected functionalized olefin copolymer to obtain the functionalized polyolefin.

2. The process according to claim 1, wherein after the deprotection step (b), a recovery step (c) of the functionalized polyolefin is carried out by a deashing step in order to separate residues of the protective species, from the functionalized polyolefin.

3. The process according to claim 1, wherein the at least one olefin monomer is selected from the group consisting of ethylene, propylene, 1-butene, 3-methyl-1-butene, 1-pentene, 4-methyl-1-pentene, 1-hexene, vinyl cyclohexane, 1-octene, norbornene, vinylidene-norbornene, and ethylidene-norbornene, or wherein the at least one olefin monomer is propylene and/or 1-hexene.

4. The process according to claim 1, wherein the at least one the functionalized olefin monomers is selected from the group consisting of: allyl alcohol, 3-buten-1-ol, 3-buten-2-ol, 3-buten-1,2-diol, 5-hexene-1-ol, 5-hexene-1,2-diol, 7-octen-1-ol, 7-octen-1,2-diol, 9-decen-1-ol, 10-undecene-1-ol, 5-norbornene-2-methanol, 3-butenoic acid, 4-pentenoic acid, 10-undecenoic acid, 5-norbornene-2-carboxylic acid, 5-norbornene-2-acetic acid, 5-hexen-1-thiol, 10-undecen-1-thiol, N-propyl-5-hexen-1-amine, N-isopropyl-5-hexen-1-amine and N-cyclohexyl-5-hexen-1-amine, 4-penten-2-amine, 3-methyl-4-penten-2-amine, 3-butene-1-thiol, and 5-hexene-1-thiol.

5. The process according to claim 1, wherein the protection step is performed by reacting a functionalized olefin monomer with an aluminum trialkyl, where the aluminum trialkyl is selected from the group consisting of: triethyl aluminum, triisobutyl aluminum, trihexyl aluminum, and trioctyl aluminum, or with a dialkyl aluminum alkoxide, R¹¹OAl(R¹²)₂ where R¹¹— is methyl, ethyl, n-propyl, isopropyl, n-butyl, isobutyl, tert-butyl, or cyclohexyl and R¹²— is ethyl, isobutyl, n-hexyl, or n-octyl.

6. The process according to claim 1, wherein the amount of the functionalized olefin monomers in the functionalized polyolefin obtained from step b) is from 0.01 to 20 mol %, with respect to the total molar amount of the olefin monomers and the functionalized olefin monomers in the functionalized polyolefin.

7. The process according to claim 1 wherein a first and a second olefin monomer are used to be copolymerized with the at least one protected functionalized olefin monomer, wherein the first and second olefin monomer are different and wherein the amount of the first olefin monomer is from 20 to 80 mol % and the amount of second olefin monomer is from 80 to 20 mol %, based on the total molar amount of first and second olefin monomer.

8. The process according to claim 1 wherein at least one of the olefin monomers is propylene used in an amount of at least 50 wt %, with respect to the total weight of the olefin monomers and the functionalized olefin monomers.

9. The process according to claim 1 wherein at least one of the olefin monomers is ethylene used in an amount of at least 50 wt %, with respect to the total weight of the olefin monomers and the functionalized olefin monomers.

10. The process according to claim 7, wherein the first olefin is propylene or ethylene and the second olefin is 1-hexene, 1-octene or norbornene, or the first olefin is propylene and the second olefin is ethylene.

11. The process according to claims 2, wherein the deprotection step is carried out with water.

12. The process according to claim 2, wherein the deprotection step is carried out with a Brønsted acid.

13. The process according to claim 2, wherein the deprotection step is carried out with a base.

14. The process according to claim 11, wherein a deashing step is performed after the deprotection step.

15. The process according to claim 1, wherein a functionalized terpolymer is obtained.

16. A functionalized olefin polymer obtainable by the process of claim 1.

17. A functionalized olefin copolymer having:
a. M_{w} range 40 to 300 kg/mol determine by High Temperature Size Exclusion Chromatography (HT-SEC),
b. Mₙ range of 20 to 150 kg/mol determine by High Temperature Size Exclusion Chromatography (HT-SEC),
c. crystallinity >30% determine by Differential scanning calorimetry (DSC),
d. melting point between 100-155° C.
e. randomly distributed hydroxyl, carboxylic acid, amine or thiol functionalities
f. a functional comonomer content of 0.05-10 mol %, and an olefin comonomer selected from the the group consisting of ethylene, propylene, 1-butene, 3-methyl-1-butene, 1-pentene, 4-methyl-1-pentene, 1 hexene, vinyl cyclohexane, 1-octene, norbornene, vinylidene-norbornene, and ethylidene-norbornene.

18. The functionalized olefin terpolymer of claim 17 having:
a. M_{w} range 40 to 300 kg/mol determine by High Temperature Size Exclusion Chromatography (HT-SEC),
b. Mₙ range 20 to 150 kg/mol determine by High Temperature Size Exclusion Chromatography (HT-SEC),
c. crystallinity range 0-30% determine by Differential scanning calorimetry (DSC),
d. melting point between 40-120° C.,
e. a first olefin comonomer selected from the group consisting of ethylene, propylene, 1-butene, 3-methyl-1-butene, 1-pentene, 4-methyl-1-pentene, 1 hexene, vinyl cyclohexane, 1-octene, norbornene, vinylidene-norbornene, and ethylidene-norbornene, a second comonomer different of the first olefin comonomer and selected from the group consisting of ethylene, propylene, 1-butene, 3-methyl-1-butene, 1-pentene, 4-methyl-1-pentene, 1 hexene, vinyl cyclohexane, 1-octene, norbornene, vinylidene-norbornene, and ethylidene-norbornene, content of 0.5-20 mol %, and a functional third comonomer content of 0.05-10 mol %, and
f. randomly distributed hydroxyl, carboxylic acid, amine or thiol functionalities

19. The functionalized olefin polymer composition according to claim 16 wherein the composition comprises at least 0.1 wt % and maximum 5 wt % of aluminum elements.

20. An article, compatibilizer, adhesive, filler dispersant, or adhesion improver in coating or paint comprising the functionalized olefin polymer of claim 16.

21. A foam article comprising the functionalized olefin polymer of claims 16, wherein the aluminum species has not been separated from the functionalized polyolefin.

22. (canceled)
